(19) United States
(12) Patent Application Publication
(10) Pub. No.: US 2002/0198748 A1
(43) Pub. Date: Dec. 26, 2002

(54) System and method for implementing an employee-rights-sensitive drug free workplace policy

(76) Inventors: Thomas M. Eden, Birmingham, AL (US); John S. Sundsmo, Vista, CA (US)

Correspondence Address: BAKER & BOTTS, 30 ROCKEFELLER PLAZA, NEW YORK, NY, 10112

(21) Appl. No.: 09/865,344

(22) Filed: May 25, 2001

(51) Int. Cl. G06F 17/60

(52) U.S. Cl. 705/7

(57) ABSTRACT

The invention includes systems and methods for training and implementing a drug free workplace program on behalf of an Entity. By using computerized processing, data storage, training, audit, authentication, certification and verification procedures, an integrated process of best practices for employee drug use detection and reduction is provided according to the invention. Specific steps for hierarchical sequence for implementation are disclosed. Secure processing and storage of information relating to random employee drug tests is provided, such that employee discipline decisions may be made on the basis of high-confidence data.

The invention relates generally to automated electronic systems and processes for delivering training, testing, and consultants in a manner effective to confirm and certify compliance with goals of (i) administering one or more drug free workplace requirements; (ii) addressing employee privacy and other concerns; and (iii) expediting marketing and sales of services and commodities related thereto.

### BACKGROUND OF THE INVENTION

Increased drug abuse in North America has been associated with criminal activities, health problems, newborn addiction, lost worker productivity and staggeringly high medical costs. Currently of greatest concern are opiates (heroin, morphine, codeine), cocaine, marijuana, MDMA (Ecstasy), phencyclidine, amphetamine and methamphetamine.

Workplace problems associated with use of cannabinoids are so great as to be considered incalculable. Surveys suggest that two hundred to three hundred million (200,000,000-300,000,000) people worldwide, and twenty million (20,000,000) in the United States, use marijuana on a regular basis, making it the most widely-used drug behind caffeine, alcohol and nicotine. Cannabinoids are now known to be fat-soluble psychoactive compounds that can persist in the body for prolonged periods of time giving rise to cardiovascular effects (e.g., increased pulse rate, tachycardia); pulmonary effects (e.g., bronchitis, increased incidence of cancer); and neurological effects (e.g., impairment in motor ability, coordination, short term memory, sensory perception, attention, reaction time, psychosis, psychological addiction, mood alteration, confusion and hallucination).

Similarly, medical and social consequences of cocaine addiction are incalculable. It is estimated that cocaine addiction afflicts at least 1.7 million (1,700,000) individuals in the United States. An alkaloid with both anesthetic and psychomotor activities, cocaine binds to dopaminergic receptors in the brain and periphery and interrupts normal pathways of neural transmission. Personality and behavioral changes associated with cocaine abuse include euphoria, paranoia, confusion, depression, anxiety, schizophrenia, hallucinations, aggressiveness, short temper, dulled emotions and poor concentration. Cardiovascular changes include constricted blood vessels and increased heart rate, blood pressure and body temperature. Death from cocaine abuse is becoming more frequent with possible mortality resulting from respiratory arrest, heart rhythm disturbances, convulsions and stroke.

Surveys conducted in 1996 suggested that an estimated 4.9 million (4,900,000) persons in the United States had used methamphetamine at least once. A University of Michigan study published in 1994 suggested that sixteen percent (16%) of high school seniors had used crystal methamphetamine at least once. Methamphetamine and amphetamine are psychomotor stimulants with effects lasting eight (8) to twenty-four (24) hours. Effects of the drug may include increased respiration, irregular heart beat, anorexia, hyperthermia, tremors, confusion, aggression, anxiety, panic, depression, convulsion, paranoid schizophrenia, hypertension, cardiovascular collapse, stroke and death. The number of methamphetimine-related deaths in emergency rooms increased from 4,900 in 1991 to 17,400 in 1994.

In the United States, the Department of Transportation promulgated regulations in 1995 for transportation and other “safety-sensitive workers” requiring that more than fifty percent (50%) of all involved employees be tested on an annual basis. In non-DOT industries, drug testing began on a broad scale after passage of the 1988 Federal Drug-Free Workplace Act. The act requires that, as a continued obligation for receipt of Federal funds, all federal contractors certify a drug-free workplace. The Federal research and special projects agency (oil, gas and pipeline), Department of Defense, Federal railroad, Federal transit and other agencies have also implemented drug testing regulations which, additionally, apply to hundreds of thousands of workers. Sweeping regulatory changes issued from the Department of Transportation under 49 CFR Part 40 in December of 2000 are likely to initiate mandatory changes that will impact millions of workers and employers.

Fourteen states have reported cost-savings when policies were implement to ensure employees a drug-free workplace. Certain employers who have instituted State-directed drug-free workplace programs have experienced premium reductions for workers compensation in the range of five to twenty percent (5%-20%). “The Boston Post Office Study” (1989) and “The Georgia Power Company Study” show insurance cost reduction benefits for employers maintaining a drug-free workforce. A recent construction industry study from Cornell University (2000) reports greater than a fifty percent (50%) reduction in workplace accidents within the first two years of implementing a drug-free workplace program. Unfortunately, while the failure to comply with Federal guidelines may result in loss of certification and funding, overzealous or poorly-administered testing programs may also result in expensive litigation by employees or job applicants. In the recent Cornell study, employers listed “legal concerns” as the single most important reason for failure to implement drug-free workplace programs. Employees may have legitimate concerns related to privacy and the accuracy or relevance of particular drug tests, and employers must be concerned with both meritorious and non-meritorious legal or administrative actions brought by, or on behalf of, employees under such theories; or alternatively, under such other laws as the Americans with Disabilities Act. Caution may be particularly warranted when an employer seeks to implement a drug testing policy, or to discipline, deny, or terminate employment, or to otherwise take punitive actions against an employee based on the results of a drug test. Clearly, it is understood in the art that the results of a scientific diagnostic assay do not constitute legal “findings” absent additional actions on behalf of the employer.

The United States Food and Drug Administration (FDA) is presently conducting hearings to investigate whether laboratory drug testing should be regulated at a Federal level. While establishing uniform standards for testing drugs of abuse may seem to be highly desirable, there are many challenges associated with implementation. At present specimen collection and laboratory drug testing are conducted in numerous different geographically-separated laboratories, regulated by different State and Federal agencies, using different tests and standards for assuring and controlling performance. While the FDA currently regulates manufacture of medical devices used in drug testing, laboratory procedures are presently not regulated by the FDA. Certification programs are presently available only for Medical Review Officers and Specimen Collection Officials.

Despite the clear and convincing need, there is currently no known systematic automated self-authenticating electronic process by which employers may ascertain the extent to which they are in substantial compliance with Federal and/or State regulatory requirements for maintaining a drug-free workplace, or may ensure that their legal liability or exposure associated with potential litigation is minimized. Thus, there is a need for systematic automated, instructive and guided process that employers may follow to implement a program for insuring a drug-free workplace. There is also a need for automated methods to achieve maximum employee drug policy conformance, while at the same time insuring employer adherence to a legally defensible policy that increases protection of employee privacy and legal rights. The prior art does not meet these needs.

### a. SUMMARY OF THE INVENTION

Disclosed herein are systematic, automated, guided, self-instructing and self-authenticating hierarchical electronic processes for more readily achieving substantial employer and employee compliance with Federal, State and insurance guidelines applicable to drug testing, as well as such other incentive programs as may be designed to maintain a drug-free- or reduced-drug-usage-workplace. In the latter context, reference will frequently be made herein to a “drug free” workplace. It will be understood that, because of the wide and ever-increasing variety of chemical substances that may be abused from time to time by employees, and because of the inherent limitations in the technological and the logistics and accuracy attainable with drug testing (as presently known in the art), it is not possible to state with certainty that any workplace is completely drug free at any particular time. However, it is known in the art that drug free workplace programs, when implemented, may substantially reduce drug usage by employees, (i.e., irrespective of whether the goal of a drug free workplace is achieved to 100% employee compliance). It is also known that implementation of drug free workplace programs is statistically correlated with benefits of increased productivity, decreased casualty loss and the like. It will therefore be understood that “drug free” as used herein with reference to a workplace, is intended to mean the various numerical levels of employee compliance, encompassing inclusively, “substantially drug free” and/or “significantly reduced drug usage incidence,” i.e., with attendant advantages such as may be measurable statistically using methods known in the art for quantifiably measuring reduced drug usage. Thus, objects of the present invention are attained in similar fashion when the invention results in a completely drug-free workplace (100% compliance), as well as any measurable reduction in drug usage, e.g., greater than 70% compliance.

The methods of the invention are preferably directed by mechanized means, wherein possible maleficent human intervention is minimized through use of electronic, e.g., computerized, processing of instruction sets designed to maximize employer conformance with applicable government guidelines and industry “best practices”, while at the same time protecting employees' rights to privacy and accurate testing (and consequently minimizing legitimate employee complaints regarding drug testing, while rendering baseless complaints more obviously frivolous and thus more readily defensible). By implementing the present invention in conjunction with digital electronic apparatus (e.g., microcomputers or other computers), it is possible not only to automate and speed the entire drug compliance process, but also to provide enhanced security and reliability through the impersonal nature of such computer apparatus. For purposes of this invention, it will be understood that a wide variety of digital electronic apparatus or computing platforms may be utilized to implement the methods set forth herein. Those skilled in the art will also recognize that digital electronic apparatuses or means as referred to herein can comprise not only hardware, but also hardware as programmed or implemented in conjunction with software (or firmware) or other memory-based programming for implementing desired computer processing routines. Authentication that an employer has properly implemented the instruction set according to the invention is also preferably determined by digital electronic apparatus/means. Certification of a facility as having successfully implemented a drug free workplace program is provided by monitoring electronic training and implementation and the authentication provided by secure electronic means.

### b. BRIEF DESCRIPTION OF THE DRAWINGS

FIG. 1 illustrates schematically an automated digital electronic data storage and instruction processing hardware system for training, authenticating and certifying compliance of an employer with drug testing.

FIG. 2 illustrates schematically a digital electronic modular control system operative in a central master control processor for maintaining hierarchical database access at a remote server and for auditing, authenticating and certifying, (as set forth in the accompanying disclosure below), the actions taken by a user at the remote server.

FIG. 3 illustrates schematically a digital electronic database architecture and interactive processes at a remote server for delivering training and setting up a drug free workplace policy, training a designated employer representative and training employees and supervisors as to common drugs of abuse.

FIG. 4 illustrates schematically a digital electronic modular hierarchical database architecture and interactive processes for selecting a collection center and training a designated employee representative in applicable Federal, State, local and insurance provider regulations (“REGS”, FIG. 4), recommendations and policies.

FIG. 5 illustrates schematically a digital electronic modular hierarchical database architecture and interactive processes for securely communicating-with, and selecting, a drug testing laboratory, a medical review officer and other specialized substance abuse professional consultants.

FIG. 6 illustrates schematically a digital electronic modular hierarchical database architecture and interactive processes for selecting a medical review officer and other substance abuse professional consultants (“REFERRAL”, FIG. 6), and for training a designated employer representative in methods for protecting individual privacy and for randomly selecting a drug test employee.

FIG. 7 illustrates schematically a secure digital electronic modular interactive process for conducting a secured electronic review of an adverse action report resulting from positive testing of an employee for a drug.

FIG. 8 illustrates schematically a secure process at a remote server for allowing a user a stepwise organized access to the hierarchical databases of FIGS. 2-7, i.e., where a central master control processor (FIG. 2) only allows access to higher level steps after lower level steps have been completed, audited, authenticated and certified-correct so that a user status level can then be upgraded to indicate compliance with requirements at that lower level.

FIG. 9 illustrates schematically digital electronic security control processes operative at a central master control processor to limit user access through a remote server (FIG. 8), i.e., to achieve the hierarchical access process of FIG. 8.

FIG. 10 illustrates schematically an electronic stepwise “status-level” (SL) method operative according to FIG. 9 for determining a user status level and using that status level to progressing a user through the stepwise hierarchical process of FIG. 8.

FIG. 11, accessed according to the method of FIG. 8-10, illustrates schematically an electronic stepwise method for setting-up a drug free workplace policy according to “Step-1”, as disclosed further below.

### c. DETAILED DESCRIPTION OF THE PREFERRED EMBODIMENTS

Recognition of the Problem: While it may be appreciated that there may be a need for standardization of drug testing, how that may be accomplished on a national and international level is unclear. Challenges associated with implementing regulatory standards and controls are well known in the field of human endeavor, i.e., human nature being such that implementation of rules will challenge to the utmost the creativity of those interested in circumventing the process. Street knowledge is widespread as to uses of adulterants and interfering substances in urine and blood test specimens. Litigation has also shown that purposeful spiking of negative specimen samples with drug, i.e., to deprecate an individual, may be a legitimate concern. Both employer and employee have strong and legitimate interests in ensuring that, if drug testing is to be implemented, then its execution and results reporting needs to be standardized, reliable and accurate. Attaining such goals poses multiple technical, legal and human-factors challenges. Drug test record-keeping presently involves human personnel who may be susceptible to bribery, incompetence, or maleficent intent. Experience has taught that if compliance cannot be monitored there is no hope of enforcement. Employing overseers to ensure the integrity of supervisors who ensure the integrity of record keepers hardly seems a cost-effective solution.

While computerized record keeping might (at first blush) seem a reasonable alternative, the multiple issues involved are each complex. First, it has been amply demonstrated that even sophisticated computer systems with seemingly unbreakable firewalls or other security provisions can be broken by creative hackers. Security is, thus, a concern. Second, if reliability of data is not ensured at every step of the data acquisition and storage chain, then high security storage of possibly-corrupt data provides only an illusory advantage. Thus, data handling is a concern. Third, there currently exists no satisfactory electronic method whereby a Federal or State agency, a private insurer, or underwriter (e.g., of a workmen's compensation policy) may determine whether an employer has implemented a drug free workplace program. As a result, at present it is difficult to determine whether the latter employer and his complement of employees constitute a good or a poor regulatory or insurance risk. Existing methods for calculating insurance premiums or premium discounts have been criticized as arbitrary and capricious. Audit, authentication, and certification capability is, thus, important. Therefore, in aggregate, while it would seem that there is a need to (i) substantially protect all aspects of drug testing from human interference or corruption and to (ii) accurately audit compliance with a drug free workplace program, the prior art at present has provided no clear way in which to accomplish these goals.

Recognizing the nature of this problem, the following reasoning was used to arrive at the processes comprising the instant invention. First, it was assumed for purposes of this invention that security for any electronic filing system, no matter how sophisticated, may eventually be broken or otherwise compromised. Second, it was assumed that any encryption system, no matter how cleverly encoded, will eventually be decoded or otherwise compromised. Third, it was assumed that all involved human personnel are susceptible to maleficent intent, corruption, or simple technical error in acquiring, evaluating, and properly recording drug test-related information. Fourth, it was assumed that not all breaches of security would be detected by the employer or program supervisor in a timely manner. Fifth, it was assumed that multiple small security “road blocks” may be more secure than a large single firewall. Sixth, it was assumed that dedicated hardwired electronics may take longer for an unauthorized party to circumvent than software. Thus, it is presently preferred that certain of the instant steps (e.g. storage of drug test information) are implemented by dedicated hard-wired electronic data-management equipment (e.g., encryption devices such as dedicated bar code readers not operating under universal recognized standards), and not by software-driven databases. Finally, it was assumed that a stepwise hierarchical process was needed to ensure user compliance with a systematic process for implementing a drug free workplace program, i.e., as set forth for example in various State-, Federal- and private-sponsored programs. That a user has conformed with and executed the instant hierarchical stepwise process may be audited. The time-spent and activities-conducted at each step may be compared to user-performance means and standard deviations to authenticate compliance. The authentication of completion of all the instant steps may be used to certify an employer in substantial compliance.

The present invention provides integrated hierarchical electronic control systems with security, checks and balances, and multiple changing keyed access systems, to ensure integrity of drug testing from setting up a drug policy at a workplace through all aspects of sample collection to possible involvement of a medical review officer, consultants, and legal counsel in an adverse action review. Although a “central master control” system is in charge, the instant processing steps rely upon distributed security control systems in “user interfaces” and “remote server” processing units. The disclosure herein, while providing processes generically useful for slowing human interference with drug testing, does not provide specific example as to how the security systems may be circumvented, because directions are provided herein for many alternative embodiments of the invention such as may be decided upon and independently implemented by those interested in practicing the invention and protecting against particular circumvention threats.

According to the disclosure herein, and processes and methods comprising the different objects of the invention, a user is provided a systematic, automated, electronic, guided, auditable, self-authenticating process for expediting and certifying substantial employer compliance with Federal and State drug free workplace guidelines. At the same time, the instant processes attain a desirably-high level of protection of an employee's rights. In other aspects, the invention provides a comprehensive systematic process by which a commercial service provider or drug testing entity may implement and oversee drug and alcohol testing at a remote site, e.g., a manufacturing plant, in a manner that effectively increases compliance with Federal and State drug-free workplace guidelines. The instant processes also simultaneously provide an audited, authenticated and certified legally defensible drug-free workplace testing program. Implementation of the instant integrated drug testing processes by an employer, insures an impartial, fair, secure and rational compliance program that has also the aims of: (i) decreasing the legal exposure of the employer in any possible lawsuits and/or adverse actions mounted by an aggrieved employee; and, (ii) increasing defensibility of the employer in the case of non-meritorious legal actions, by virtue of the independent audited, authenticated and certified documentary electronic evidence provided according to the processes of the invention.

In other objects, the instant processes provide a combination of both electronic records, i.e., such as may be maintained in a computer database, and instructions issued from an automated electronic system requiring completion by an operator of one or more hardcopy forms, e.g., questionnaires and/or check lists. Preferably, the instant hardcopy documents are maintained in file cabinets and the scanned documents are maintained in databases.

In yet other objects, the invention provides standardized methods for certification of drug-testing personnel, e.g., those individuals involved in collection, processing, testing and reviewing of drug test data.

Certain terms used herein shall have the following defined meanings for purposes of this disclosure:

“Integrated” shall refer to and signify the fact that each step of the instant process builds upon, and requires that, the former process steps have been performed. Preferably, completion of each required action within each step of the instant process is confirmed by electronic auditing, authenticating and/or certification and each of the resultant certificates are stored in an electronic file, e.g., a computer file. The steps of the invention are thus interlinked and multiply dependent the former on the latter by virtue of the requirement for a sequential series of electronic audits and certificates. Thus, according to the process of the invention, it is required that the multiple Steps be performed in a stepwise manner to achieve the desired results

“Audit” is intended to mean an electronic examination of electronic records stored in a database detailing the activities of an operator/user at a step in the instant process. Representative electronic records (“electronic records”) include: records of user queries and system responses; records of user actions-taken; records of the time-spent by a user in completing each action and the like.

“Authentication” is intended to mean the process of determining the validity of the user's actions, referred to herein as “user activities”, through an audit (supra) wherein each of the electronic records is compared to a historical log of normal activity values to determine whether the user actions-taken, or user time-spent performing an activity, conform with the norm, e.g., whether the actions fall within a range of mean normal action values and responses as set forth in an electronic comparisons if-this-then table. Such mean normal action values and responses may be deemed “model” values and responses, which are not necessarily representative of the optimal, proper, or only acceptable such values or responses, but can be regarded generally as accurate estimates of appropriate or typical user participation, and thus may be used as dynamic benchmarks for evaluation of subsequent users. Representative examples of user activities include tracking both the pattern of progression and sequential accessing of materials by a user, as well as, the time spent in analyzing those materials once accessed. Thus, normal user activity values may comprise both patterns of database and file access as well as time spent by a user in access mode in different files and database. Authentication is achieved electronically by comparing either, or both of, the qualitative access patterns and the times spent against a table of normal values, and by determining that authentication is appropriate if the user activities and/or times fall within the range of normal values, e.g., within the range of mean+/−standard deviation.

“Certification”, when used in regard to the instant processes, is intended to mean the process of determining and attesting that the authentication process (supra) is substantially complete, i.e., within the ranges allowed in an if-this-then table, thereby confirming substantial compliance of a user with a single step in the instant process, i.e., the user has met the requirements for certified completion of that step.

“Certified drug-free workplace” is intended to mean that the process of collecting certificates (supra) for each step of the instant process is substantially complete, i.e., within the ranges allowed in a series of if-this-then tables, thereby confirming that the user has met the requirements as set forth in the subject tables for completion of at least Steps 1-5, preferably Steps 1-7, most preferably Steps 1-8 of the instant process, as set forth in detail in the accompanying disclosure.

“Certified adverse action review” is intended to mean that the process of collecting certificates (supra) for Steps 1-12 is substantially complete, i.e., within the ranges allowed in a series of if-this-then-tables, thereby confirming that the user has met the requirements for conducting a legally defensible adverse action review of an adverse event, e.g., a positive drug test laboratory result as confirmed by a medical review officer.

“Digital electronic means” is intended to mean that the instant processes are substantially completed using electronic processors, e.g., computer processing units, to process instruction sets, e.g., programs, that may optionally be organized into software processing modules, i.e., as set forth further below.

“Designated employer representative”, abbreviated DER, is intended to mean an individual selected by an employer to communicate with and receive communications from: a medical review officer (abbreviated herein, MRO), a drug test laboratory, a breath alcohol technician (abbreviated herein, ABT), a substance abuse professional/consultant, or the like. The subject DER is commonly authorized to arrange for collection of a test sample from an employee and to take immediate action to remove impaired employees from safety-sensitive duties. The subject DER is also commonly authorized to train employee awareness in the dangers associated with use of drugs of abuse. The subject DER commonly undergoes training in the policies and methods by which to establish, implement and administer a drug free workplace program at a facility. Representative facilities include manufacturing plants, service businesses, shipping facilities, trucking companies, railroads, pipelines, refineries, chemical plants, penal institutions (e.g., prisons, jails, and the like), schools and the like.

“Drug free workplace program” is intended to mean an administrative program, for establishing at a facility a drug policy, a DER, an employee awareness training, a random selection process for testing, a procedure for accessing a drug test assay, a process for reviewing results of the subject testing and a process for reviewing and acting upon adverse events.

“Adverse event” is intended to mean a positive drug test result achieved in a drug test assay using a test sample collected from a drug test employee.

“Hierarchical,” when used in regard to the instant databases as accessed according to the instant methods and processes, is intended to mean that the instant methods comprise a substantially-stepwise access to the respective different databases and that certain steps must, as a substantive requirement, be performed before other steps may be performed. It is also intended within the meaning, that certain steps comprise higher level activities that cannot be performed until other, lower level activity steps have been performed and that certain policies and training have been conducted by a user. Thus, while certain lower level steps may be interchangeable in the order in which they are performed, e.g., the steps of establishing a facility-wide drug policy may be performed before or after the steps necessary to train and certify a DER, those skilled in the art will recognize that a logical progression exists for the performance of the subject lower level steps before the higher level may be implemented, e.g., before testing can be conducted, a test laboratory or assay methodology must be selected and a program for testing must be in place. It will be understood, also, that merely varying the order of one step, or a small number of steps, will not detract from the hierarchical nature of the present invention's process, although it is contemplated that the hierarchical ordering of steps will function most efficiently for purposes of this invention when the hierarchies or orderings described herein are followed exactly.

“Drug test employee” is intended to mean an individual subject to collection of a test sample for purposes of submitting the test sample to a drug test assay.

“Test sample” is intended to mean a sample of a bodily fluid or tissue. Representative examples of bodily fluids include saliva, sweat, urine, blood and the like. Representative examples of tissue samples include body hair, skin scraping, nails and the like.

“Drug test assay” is intended to mean an experimental procedure performed on a test sample using a medical diagnostic assay device for the purpose of detecting the possible presence or amount of an analyte in the test sample. The subject test procedure may e.g., be performed on-site, i.e., at the employer facility, or alternatively, in a diagnostic laboratory. Representative examples of the subject drug test assay include a variety of enzyme-linked immunoassay devices, radioimmunoassay methods and methods employing gas chromatography (GC) and mass spectrometry (MS), e.g., tandem GC/MS, as are known in the art or as may be later developed and implemented as accepted drug testing methodologies. As an optional feature of the present invention, consumer data regarding the performance of a diagnostic laboratory may be collected including e.g., responsiveness, confidentiality, consumer confidence, performance results reported on control validated “spiked” drug-positive samples and the like. As an additional optional aspect, data relating to the technical performance of a laboratory test, manufactured diagnostic test device, or other assay methodology, may be collected, stored and used to make calculations such as those known to those skilled in the diagnostic arts, e.g., accuracy, precision, specificity, sensitivity, “false positive” and “false negative” rates, and the like. It is anticipated that the latter performance data and calculations, as part of the instant invention, may be made available to users so that a DER, and/or MRO, may more readily make informed decisions with regard to the suitability and performance characteristics of particular assays and diagnostic test laboratories.

“Validating assay” is intended to mean an experimental procedure performed on a test sample using a medical diagnostic assay device for the purpose of detecting the possible adulteration of a test sample. The subject test procedure may, e.g., be performed on-site or in a diagnostic laboratory. Representative validation assays include those testing for the concentration of a normal urine constituent, e.g., creatinine or specific gravity, to determine whether a test sample has been diluted as well as assays specifically designed to detect adulterants.

“Collection”, when used in regard to a test sample, is intended to mean the process of obtaining a test sample from a drug test employee.

“Hierarchical control”, when used in regard to the instant processes, (and user access to instructional, informational, and implementation materials provided according to the methods of the invention), is intended to mean that control is exerted over access such that a user must complete lower level activities before access to higher activities is allowed. “Lower” and “higher” are intended to refer in a relational manner to the position of activities within the subject hierarchy of control. Representative examples of activities, and higher and lower level activities, are provided further in the accompanying disclosure, i.e., below. For sake of organization, the subject higher and lower activities are grouped into twelve “steps” (set forth below), i.e., each step in turn constituting a series of internal activities necessary for a user to complete a one or more tasks. The subject steps constitute the instant stepwise process, i.e., constituting an ordinal stepwise progression toward implementing, maintaining and certifying a drug free workplace program.

“User”, is intended to mean a human being.

“Entity” is used interchangeably with “Facility” and/or “Employer” to mean inclusively the recipient of the instant automated electronic processes for implementing at a facility a drug-free workplace program. Representative examples of workplace facilities operated by entities include operational manufacturing sites, distribution centers, transportation centers, corporations, partnerships, organizations, drug-testing service providers, consultants, Federal and State Agencies and the like. Entities may also include any individual or group of individuals responsible for health of, or performance of, a population of individuals, e.g., such entries may include those responsible for activities: e.g., in transportation (US DOT, FAA), at correctional facilities, schools, drug treatment clinics, athletic leagues and the like.

“User Interface” is intended to mean an electronic device responsive to the instructions of a User and including a data entry apparatus, a conversion apparatus, and a transmission apparatus, as disclosed further below. Examples of the subject data entry device include, but are not limited to, voice, key-pad and touch operated keypads, keyboards, microphones and the like. Examples of conversion devices include telephonic and wireless modems, radio transmitters, Ethernet LAN converters and the like, i.e., any device or program capable of accessing telephone company lines and/or directly accessing or linking to one or more computers such as in a data network. a variety of data networks, including distributed data networks such as the internet (a public network) or intranets (usually private networks) are known and may themselves be interconnected through a number of transmission modalities. Examples of transmission devices include telephone company lines, wireless frequencies in the air, dedicated internet and intranet connections, and the like as enabled by the conversion device. Representative user interfaces include personal computers, PDAs, cellular telephones, wireless PDAs, dedicated electronic devices and the like.

“Central Master Control” is intended to mean a secure autonomous possessing system responsive in an “IF-THIS-THEN” logic manner only to certain proper secure instructions from a User Interface. “IF-THIS-THEN” is intended to mean such software logic-state-responsive programming as shall identify that the subject Central Master Control system may reject instructions from the User Interface, e.g., responsiveness to ONLY commands and the like. Representative examples of instructions that may be rejected include those issued from the User Interface that do not comply with Security provisions, Access Level authorization (“status levels”, also referred to herein interchangeably as “access levels”, as disclosed further below), norms of activities and the like. The subject meaning of the term is intended to indicate that the subject central control has “master”—level control over the activities at the User Interface, i.e., the User Interface is a “slave”.

“Access Level”, also referred to herein interchangeably as “status levels”, abbreviated SL, when used in regard to accepting or rejecting an instruction issued from a User Interface, is intended to mean each with a series of certificates issued by a Central Master Control to a User upon audited and authenticated completion of each of a series of twelve individual Steps comprising the instant methods, i.e., as disclosed in greater detail in the accompanying disclosure below. According to objects of the invention, the instant access level designation is useful for (i) identifying the highest level of Steps completed (i.e., a “status level”) by a User engaged in the instant process of implementing the instant processes; (ii) ensuring stepwise performance of the instant hierarchical processes by the User; (iii) determining a level of training and experience of a DER; (iv) issuing a certificate identifying the drug-free workplace status for an Entity; and the like. The accompanying disclosure identifies certain methods by which issuance of the instant access level designators, issued in a sequential manner, is used to direct a User through the automated electronic process comprising the instant invention.

“Training Module” is intended to mean one or more software programs whose purpose is to deliver teaching materials as needed, and as selected by a User for training as to how certain tasks should be performed. Representative training modules include: (i) Setup training, i.e., to acquaint a User with the activities necessary to implement a drug free workplace program; (ii) DER training, i.e., to train a DER in professional responsibilities associated with the position; (iii) testing training, i.e., to train a DER in the collection and testing of drugs of abuse; (iv) adverse event training, i.e., to train a DER in how to deal with a positive drug test result; and the like.

“Implementation Module” is intended to mean one or more software programs whose purpose is to provide a step-by-step checklist, site-required and regulatory agency-required forms and the like, necessary to complete a Step within the instant process. Representative examples of the subject implementation modules are provided in the accompanying disclosure below.

“Software” is intended to mean a plurality of processing instruction for execution by an electronic processing unit. The subject processing instructions are commonly stored in one or more read-only computer memory files, although, in alternative embodiments one or more of the instructions may be hardwired. “Hardwired” is intended to mean that the subject instructions may comprise one or more circuits (e.g., switches) within an electronic architecture, e.g., such as may be installed within one or more computer chips or within one or more dedicated electronic devices.

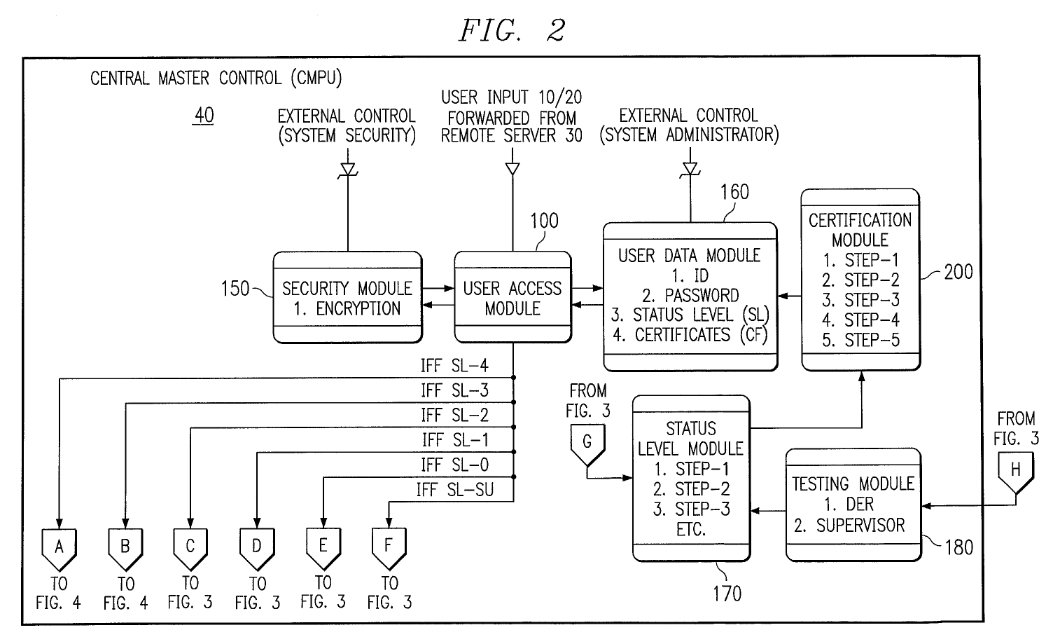

Embodiments of the invention provide interactive automated electronic stepwise processes for tracking employer compliance with a drug free workplace program in a manner effective to certify such compliance as set forth supra. The subject drug free workplace program consists, in its most elemental form, of a periodic random selection of a drug test employee from among a plurality of other employees at a facility. Employee compliance with the drug free workplace program is effected by the deterrent value conferred by such a random testing process. Test samples are commonly obtained by trained and certified “collectors” at local and/or regional sites. The samples so-collected are then submitted for drug testing at a “test laboratory”. Embodiments of the invention provide for testing of the subject samples either (i) in an on-site screening assay device, i.e., to identify the small number of possibly positive samples needing additional testing, and/or (ii) in a laboratory based assay system. Embodiments of the invention, as set forth further below, include automated electronic methods for tracking samples so collected throughout the testing process in a coded manner effective both to protect individual employee rights and to certify compliance with state, federal and insurance drug-free workplace regulations and policies. The instant process for tracking employer compliance consists of a stepwise process. As a first step, training is delivered to a “designated employer representative” (DER), i.e., utilizing a training module, then an implementation module and then, optionally, a testing module to certify the individual has the requisite understanding of the duties and obligations resident in the DER. All actions, queries, responses, elapsed time and the like of a user are preferably recorded in a session log, i.e., an electronic record of activities during the subject session. That training has effectively been completed by the DER is preferably ascertained by auditing (supra) the session log and authenticating (supra) the training resources accessed by the individual at the training module and/or by conducting optional electronic testing at the test module. According to standards established by an outside reviewer, the performance of the DER at the training and/or the testing modules may be used to certify compliance, i.e., at a compliance certification module. Commonly, the compliance module is capable of (i) reviewing the session log, and/or audit or authentication data, relating to the actions of the DER at both of the training and the implementation modules, (ii) comparing the DER actions to a plurality of acceptable actions in a requirements if-this-then table and (iii) determining whether the subject actions and the subject acceptable actions are the same or are different. If the latter actions and acceptable actions are the same, the DER is next issued an increased access “status level” (SL) entry designation so that the next step in the stepwise process may be accessed. Starting at the SL entry level “SU”, i.e., setup, a DER is led stepwise through SL levels 0-10 as depicted in FIGS. 2-4. According to the instant process, only individuals trained and certified as DERs will be allowed access to any status level other than SL-SU (i.e., setup). Access restriction is preferably maintained through a combination of passwords and system initiated queries of a user. For example, the subject queries may ask the user to provide personal information, e.g., mother's maiden name, or business information, e.g., CEO's initials, and the like. (In particularly sensitive positions, provision is also made for fingerprint and/or retinal mapping identification.) Advancement from any first SL step to any second step within the instant automated electronic stepwise process requires issuance of the increased SL designation, i.e., with attendant audit, authorization and certification. The increased SL designation, in turn, is used for issuance of secure entry/access keys, e.g., encryption keys issued by a security module. The instant process functions (i) to limit unauthorized assess; (ii) to ensure a proper organized progression of an authorized user through the instant hierarchical stepwise process; and (iii) as a logical means for tracking employer implementation and compliance with drug free workplace policies. The instant methods achieve oversight of the employer's activities in a manner effective to certify “drug free status”, i.e., by periodically determining user status level and reviewing audit, authorization and certificate information stored e.g., in a dedicated user database. Preferably, certification of an employer's “drug free status” includes attainment by the DER of at least an SL-2 designation, i.e., training of the DER and drafting of a drug free workplace policy. More preferably, the subject “drug free status” certification includes evidence (stored in electronic and/or hardcopy form) of satisfactory completion of requisite training for the DER, supervisors and employees, i.e., an SL-4 designation. Most preferably, the subject “drug free status” certification includes electronic evidence indicating implementation of random selection and testing, as disclosed further below. An SL-4 designation is effective to establish that the DER has accessed training modules and implementation modules at the SL-SU, SL-1, SL-2 and SL-3 levels, and that the activities conducted at those modules have been audited, authenticated and certified. In the latter case, the subject activities constituting those currently believed by policy makers to be most effective in establishing: (i) a drug free workplace policy, (ii) a training and a certification process for the DER, (iii) an employee awareness training program, and (iv) a training of supervisors. In the presently most preferred embodiment, the auditing, authenticating and certification at each step are used to establish employer compliance and validity of random selection and testing (initiated by the DER), as well as compliance with requirements for conducting any possible adverse action review. The instant processes are useful for confirming the drug free status of an Entity in a manner that has not been possible previously using manual means.

In other embodiments, the invention provides systematic, automated, electronic, guided, self-auditing, self-authenticating, self-certifying and time-saving processes for increasing employer compliance with Federal and State drug free workplace guidelines while at the same time protecting employee right to privacy and to accurate drug testing results. In other objects, the invention provides a comprehensive systematic process by which a commercial service provider or drug testing entity may conduct drug and alcohol testing at a remote site (e.g., a factory) in a manner effective to increase compliance with Federal and State guidelines for a drug free workplace at that site, while simultaneously providing a more legally defensible program that protects the privacy concerns and rights of the employee at the remote site.

In other embodiments, the processes of the invention provide that certain of the instant steps comprise methods implemented in one or more software training modules. The subject training module preferably comprises at least instructions whereby an automated interactive electronic system is employed to deliver user-directed drug free workplace training and/or to provide answers to drug testing questions, as prompted by the subject electronic system, and as queried by a DER user in response to the subject prompting. In a presently preferred embodiment, training or answers are delivered in response to queries and requests issued by the user DER.

In still other embodiments, the processes of the invention provide that, in addition to electronic records such as may be maintained in a computer database, certain of the instant steps comprise a software drug free workplace implementation module. The subject implementation module preferably comprises at least instructions whereby an automated interactive electronic system is employed to produce one or more questionnaires, Federal or State regulatory forms, insurance reporting forms, check lists for assuring drug free workplace compliance and the like. The latter electronic materials, so provided, are preferably completed electronically by a DER user in a query-response session and the subject User responses are stored in a file, e.g., with an additional optional printed file copy.

In other embodiments, the invention provides stepwise electronic training verification and validation by auditing, authenticating and certifying (defined supra) user-directed activities and their duration. The instant processes provide for auditing the activities of a plurality of “normal” users thereby to determine a “normal pattern” of activities as well as “normal performance values”, i.e., a mean duration and range of time values for each activity. The subject mean duration and range are used to set training performance values that are used, in turn, to authenticate the activities of Subsequent Users. The latter Subsequent User activities falling within the subject normal pattern and range of performance values are authenticated, while user activities falling outside the subject normal performance values are used to signal the system to issue one or more user queries designed to determine a reason, e.g., a failure to understand material as provided, an interruption or a delay, lack of attention and the like. Failure to respond, or inappropriate response, is used to signal a Security module, the user session is terminated, the session log is audited, proper activities authenticated and findings transmitted to a certification/status level access module for review.

In other embodiments, the invention provides a remote server, or in other embodiments a central master control, each of which is capable of directing and controlling access to drug free workplace training and implementation materials stored at a user interface, e.g., in program files, on a CD-ROM, or a DVD storage device. The subject remote and central control methods are most useful in at least the following ways: namely, (i) for policing against intruders; (ii) for auditing, authenticating and certifying User activities during training and implementation of drug free workplace policies (as set forth supra); for improving the quality of the presentation materials; (iv) for providing help, and (v) for insuring that materials provided to the user are in conformance with the most recent interpretation(s) of the statutes, code, and regulations and the like. The subject master control is preferably enabled using either a secure private network (e.g., secured dedicated dial-up or permanent T1 access and the like) and/or internet communications through a secure socket with encrypted hyperlinked communications. Most preferably, the subject master control is enabled using access through a secure dedicated telephone company line connection into a secure private network.

In other embodiments, the instant process provides electronic documentation and processes which may find use in reducing an employer's perceived legal liability and/or exposure associated with drug testing. The Columbia study (supra) identified employer perception of legal liability as a leading cause for failure to implement a drug free workplace program. The instant system aims to reduce that perceived risk i.e., by electronically documenting User access to interactive electronic training aids (supra), checklists, forms and other materials (supra) for implementing a drug free workplace program, thereby documenting an employer's attempts to fully comply with all applicable regulations. Since the instant electronic system also includes security provisions (supra) for ensuring protection of each individual employee's rights to privacy, due process, accurate test results and the like, an employer can make an improved case that he/she has reasonably attempted to protect all applicable human rights.

In other embodiments, the instant invention provides processes for rapidly changing training, checklists, and all manner of materials needed to train and implement a drug-free workplace program at a User Interface. The instant process involves processing queries issued at a User Interface and instructions at a Central Master control processor (as defined supra), and with the requirement that all materials accessed at the User Interface are under the instructional control of the Central Master control processor. In one representative example, a query issued at a User Interface for access to materials located on a CD-ROM storage device at the User Interface is rejected by the Central Master control process and instead the access request is directed to a Remote Server where updated materials are on file. Accordingly, rapid changes may be implemented with the advantages that: (i) a User may transparently have access to the most up-to-date material, whether it is available at the User Interface or at some other electronic site; and (ii) outdated CDs, DVDs and other stored materials at the User Interface may be replaced in a more leisurely manner, e.g., by the U.S. Postal Service.

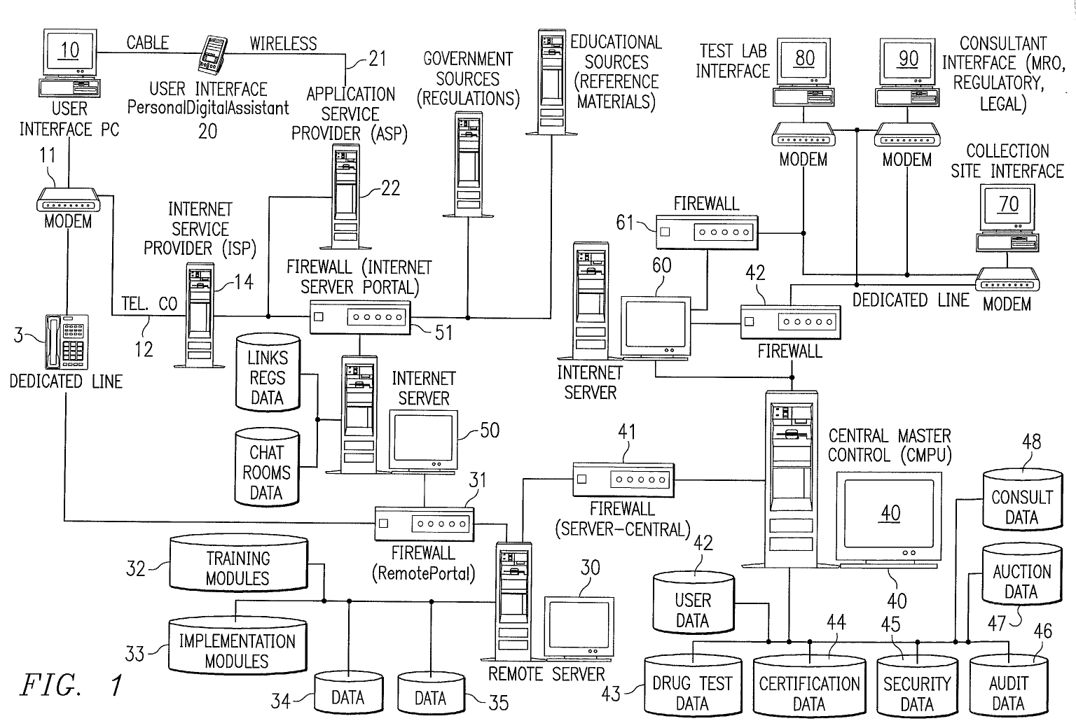

In other embodiments, the invention provides a User interface that is an access portal to a Central Master Control Processor, also referred to herein as the Central Master Processor Unit (abbreviated CMPU). The User interface may access the CMPU directly, but access is preferably not direct, by instead through a Remote Server. A representative CMPU, Server and User Interface hardware architecture is illustrated in FIG. 1.

In other embodiments, the invention provides a hierarchical electronic process for sequentially accessing a plurality of files and/or databases each of which contains data and/or processing instructions necessary for delivery of training, implementation of policies, security, auditing, authentication and certification effective to establish User compliance with the requirements for establishing and implementing a drug-free workplace policy. The instant security software processing instructions involve multiple levels of access, “status levels” as referred to supra, each level of processing requiring certification at a next lower level before access is granted to the next higher level. The instant access level controls are administered by processing of instructions stored in files comprising an Access Control Module and a Security Module, i.e., each of which modules comprises a plurality of software processing instructions. The instant Security Module, i.e., software as defined supra, reviews access requests, user codes, access level certificates and instructions, issues secure encryption keys, and issues Database Access Keys to the Access Control Module (also software). The instant Access Control Module processes instructions from the User Interface; accesses client/Entity information stored in a User File at the Central Master Control processor including authorized Users. The Access Control Module also conducts audits authenticates activities, issues certificates and reviews certificates issued that, in turn, determine the user Access Level. The Security Control Module, after review, determines whether the instructions issued are from an authorized User and sends instructions to the Access Control Module. The Access Control Module, in turn, reviews the User File and determines which databases are accessible at the indicated User based on the current recorded Access Level designation in the User File. If the User directed query for database access is allowable at the current User Access Level then the Access Control Module retrieves Database Entry Keys from the Security Module and issues the keys to the User for the duration of a Working Session at that particular Access Level. If the User advances to the next Access Level during a Working Session, (i.e., after audit, authentication and certification), then the Access Control Module requests and retrieves new Database Entry Keys from the Security Module. Thus, it is understood that the Database Entry Keys are effective for the duration of a single Working Session and for User assess at a single Access Level.

In other embodiments, the invention provides security for accessing a plurality of electronic files and/or databases stored in the following hardware units: namely, a User Interface, a Remote Server and a Central Master Processor. According to the instant security provisions, database access at the Remote Server and/or User Interface is restricted in a lock-and-key fashion, i.e., Database Entry Keys, issued according to processing instructions stored and executed solely at the Central Master Processor.

In other embodiments, the invention provides twelve integral and preferably hierarchical, sequentially implemented steps for implementing a drug free workplace program at a remote site through a User Interface. The subject steps are preferably performed independently, i.e., each by separate software modules secured at separate and distinct Access Levels. At each step master control is exerted and access is preferably sequentially gained to higher and higher level activities, i.e., hierarchical control is exerted over user activity. Requests for access to higher than allowed Access Levels are refused. Requests for access to lower than currently allowed Access Levels are queried to determine the nature of inconsistency.

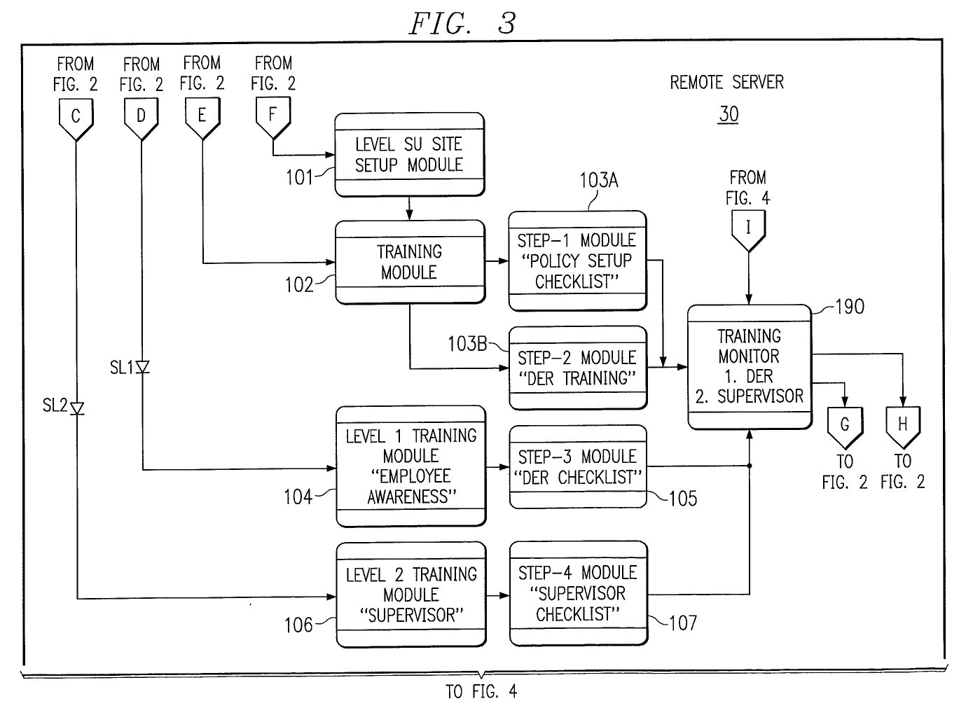

As a first representative example of hierarchical functions, work force training in drug policy is not provided until a facility drug policy is adopted and a DER trained and certified. As a second example, prior to collecting a test sample for submission to a diagnostic test laboratory a certified collection site is chosen followed next by selection of a test laboratory. The subject twelve steps are set forth in the following disclosure and accompanying hierarchical block diagrams of FIGS. 3A-3B, i.e., from higher level at the bottom to lower level (startup activities) at the top. Thereafter in the disclosure, there appears a description of the electronic instructions, controls and procedures for implementing the instant 12 Step process.

Embodiments of the invention provide a stepwise automated electronic process for developing a drug free workplace program consisting of essentially twelve ordinal or seriatim steps, each comprising one or more activities, set forth as follows: namely,

Step 1. Development of a Drug-Free Workplace Policy:

The instant invention provides that the foundation for a more effective and legally defensible drug and alcohol testing policy is based in a policy manual effective to place a facility in compliance with one or more state or a federal statutes, codes or regulations or with one or more workplace requirements suggested by a corporate management organization, consultant, industry- or scientifically-recognized best practices, or an insurance provider. The subject testing policy is commonly developed as an employee manual consisting essentially of: (i) a drug policy statement; (ii) a lay presentation of drugs constituting drugs of abuse with their adverse actions; (iii) a listing of substance abuse resource information; (iv) one or more consent forms effective to obtain consent from employees to random drug testing; (v) one or more acknowledgment forms effective to determine that an employee has been placed in possession of the drug policy statement, and/or made aware of the existence of a drug-free workplace; and (vi) a toolkit comprising the several forms commonly needed by a Designated Employer Representative (DER) to implement a drug free workplace program. The subject toolkit comprises checklists and forms further disclosed in relation to the instant Steps which are set forth in greater detail below. Representative examples of forms included in the subject toolkit include: one or more “reasonable suspicion” checklists; a “last chance” agreement; an “accident investigation” form; a “rapid screening” form; a “safety-sensitive position evaluations” checklist; and one or more forms effective to place an employer in compliance with a state or federal regulation, code, or statute. It is anticipated that setup of the subject drug-free workplace policy will involve a determination of a least the type of entity, the applicable regulations, codes and statutes, i.e., based on the particular type of business activity conducted by the entity and the applicable regulatory requirements.

To maintain security, access at Level-SU is open to a User having a password and demonstrating appropriate Client-directed authorization, i.e., referred to herein as Access Level “SU” (setup). Access to all higher levels, i.e., referred to herein as Access Status Levels, (set forth below), requires sequential proof of completion of all requirements at the preceding lower access level. According to the instant methods, access is controlled by a Central Master Control processor having an Access Module and a Security Module, the functions of which are disclosed supra and illustrated further below.

According to the invention, implementation of Step 1, i.e., development of a drug-free workplace program, involves an interactive session conducted by a User and an Access Level-SU (“Set-Up”) Module that, in turn, first provides access to a Level-0 Training Module (i.e., software) where basic information is provided on requirements, forms, Steps to establishing a drug-free workplace program, and the like. From the Access Level-0 Training Module the User is transferred to an Access Level-0 Implementation/Setup Module (i.e., software) consisting of a query-and-response directed decision tree for setting up a custom drug-free workplace policy for an Entity. According to presently-preferred embodiments, at the Access Level-0 Implementation Module a User is required to answer about fourteen (14) questions or select from among a smaller number of organized series of options. Based upon the User response, instructions resident in the implementation module software, e.g. in an if-this-then table, are processes and the User is provided with a customized drug free workplace policy manual effective to place the Entity in substantial compliance with applicable Federal, State, local and insurance regulations. The latter interactive process preferably requires only about ten (10) minutes to about twenty (20) minutes of elapsed User session time, Representative examples of questions addressed to the subject User include: (i) type of business (e.g., transportation of goods or people; manufacturing; distribution; communications radio, television and the like) and location; (ii) regulations known by the User to relate to the business of the Entity (e.g., DOT, FAA, FTC regulations and the like); (iii) current regulatory status of the Entity (e.g., new business, existing regulated business, and the like); (iv) public/private status of the Entity; and the like. In a presently-preferred embodiment, the User, acting on behalf of the Entity, prepares a printed copy of the Policy Manual and copies are distributed for management and legal review, e.g., by corporate counsel. It is anticipated that the User will electronically enter Revisions to the Drug Policy Manual, i.e., suggested by management and requested by Counsel, and that these revisions will be stored in a User File at the Central Master Processing Unit. Acting under the assumption that two heads are often better than one, Central/Master control will review the subject entered Revisions for purposes of improving and revising its own documents, as well as, for checking appropriateness and providing possible legal/regulatory consultative services to the Entity and/or the Entity's Corporate Counsel. It is anticipated that as the interpretations of the law and regulations changes, so too Policy Manuals will necessarily change over time and so continued diligent oversight will be necessary to ensure that a User is receiving the most recent applicable materials and advice. Embodiments of the invention provide the methods for delivery of this diligent oversight and review in a time- and cost-effective manner.

In a presently-preferred embodiment, the informational materials provided in the Access Level-0 Training Module are stored on a read-only CD or DVD disk at the User Interface while Security, Oversight, and Access rights to the materials stored at the User Interface are preferably provided by a Central Master Control Processing acting either through a dedicated telephone company line (i.e., a dial-up connection), a secured internet socket, or an otherwise-secured intranet or network data connection. As implemented for use over the internet, representative current encryption systems include those denoted as the Secure Socket Layer (SSL) and IPSEC protocols.

Communications between a User Interface and a Remote Server or Central Master Processing Unit (e.g., FIG. 1) may be secured according to any one of, or several of, the methods and protocols known in the art. In non-reciprocal data encryption systems, such as described in U.S. Pat. No. 4,218,582, a first party to a communication generates a numerical sequence and uses that sequence to generate non-reciprocal and different encrypting and decrypting keys. The encrypting key is then transferred to a second party in a non-secure communication. The second party uses the encrypting key (called a public key because it is no longer secure) to encrypt a message that can only be de-crypted by the decrypting key retained by the first party. The key generation algorithm is arranged such that the decrypting key cannot be derived from the public encrypting key. It is anticipated that other methods known in the art for using non-reciprocal keys for authentication of a transmission will also be useful according to the methods of the invention. In the latter non-reciprocal authentication, reference to the non-secure “public” key is preferably used to denote the tool for decrypting a message that has been encrypted using a secure “private” key known only to the originating party. Accordingly, the receiving party has assurance that the origination of the message is the party who has supplied the “public” decrypting key.

Similarly useful for securing communications between a User Interface and a Central Master Processing unit according to the instant methods, U.S. Pat. No. 5,978,918 describes a method for supplementing security protocols in conjunction with SSL/DES encryption, using public key encryption, and employing a dedicated communication line for non-internet communication of private data. U.S. Pat. No. 5,781,632 discloses a method and apparatus for securing transmission of data using standard encryption in conjunction with data switches.

A variety of often-disparate standards for encryption and decryption have evolved. Implementations of these standards are generally readily available in off-the-shelf form. Some of these standards are considered “strong” or high-security encryption standards, and others are considered “weaker” or lower-security. Generally speaking, the “strength” of an encryption algorithm correlates with the complexity of the encrypting process. Each level of encryption standard may have utility for certain applications, and for a certain duration of time. At the current time, 128-bit and 448-bit encryption standards as supplied for internet use may be considered strong or high-security encryption modalities, and could efficaciously be implemented for securing sensitive data in the present invention, but the invention may be implemented with a variety of known (or future-developed) encryption and other security provisions, including a combination of security provisions (preferably somewhat redundant multiple layers of disparate security provisions, which can be implemented as software or hardware “modules” (or both) at selected Steps of the present invention, i.e., presenting multiple barriers between Steps and within Steps to limit access events that might compromise system security). By providing an overlapping (or partially-redundant) plurality of security provisions (which may be regarded interchangeably as security modules within a block system diagram, or as security routines within a processing flow), it is possible to enhance security by increasing the complexity of purposeful or inadvertent breaches of any particular security module.

In other embodiments, the invention provides methods for encrypting employee drug testing information through dedicated electronic means, e.g., using a bar code reader equipped with a microprocessor for decoding bar codes and encrypting communications equipment for transmitting the decoded data to a remote server. Equipment suitable for modification to the instant uses include those disclosed by Walsh in PCT/US96/09594 (WO96/41448) and PCT/US96/09407 (WO96/41447). However, unlike Walsh who discloses decoding universal bar codes, embodiments of the invention provide for use of customized non-universal bar codes and customized decryption means. The security advantage provided herein when applied to coding of employee drug testing information lies in the lack of any easily identifiable characters. Thus, a casual observer would not easily discern confidential information and even a sophisticated cryptographer would require some time to decode the information conveyed thereby. Accordingly, in other embodiments the invention provides means for secure bar coding of employee information at a collection site which reports the identification information via encrypted means to a CMPU. The subject bar-coded identification is subsequently used as the identification number at a testing laboratory which, in turn, reports the results via encrypted means to a CMPU. In this manner, only the CMPU should know the identity of the employee and the resultant test result for that employee.

Step 2. Identifying and Training a Designated Employer Representative:

The instant invention provides that the foundation for an effective and legally-defensible drug and alcohol testing policy is based in identification and training of a User responsible for implementation of a drug-free workplace program at an Entity, i.e., referred to herein as a designated employer representative (DER), i.e., as defined supra. It is anticipated that in certain regulated industries training and competence of the DER may require periodic testing and/or certification. As in Step 1, it is preferred that oversight be exerted by a Central Master control over the DER training, (i.e., at both of the Access Level-0 Step1 and Step-2 Training Modules), and instructional activities at a User Interface. It is also preferred that Access Level control be exerted to ensure that training materials are accessed in a meaningful instructional manner. It is also envisaged that Oversight exerted by the CMPU, e.g., by maintaining session logs consisting at least of materials accessed and time spent in analysis of the instructional materials. The latter session logs are preferably used for auditing, authenticating and certifying training of a DER (as set forth supra). It is also anticipated that access to outdated materials at a User Interface may be restricted, with, e.g., up-to-date materials being supplied instead from either a Remote Server or from a source at the Central Master control unit. Advantages that may be conferred by the instant access control process include at least: (i) up-to-date materials can be made available at most or all times to the User; (ii) freedom to replace instructional materials at the User Interface in a more leisurely manner; and (iii) lessening the chances of a User accidentally employing an old and/or outdated CD or DVD. In this manner, the instant processes provide methods for rapidly changing instructional materials in response to changes in the law, the regulations, and the interpretations of the Courts, the agencies of government, and the insurance providers.

Representative examples of methods and materials useful for DER training in Step-2 include: (i) written materials, codes, instruction manuals, layman's summaries of applicable legal and regulatory principles, and the like; (ii) recorded classroom instruction (e.g., DVD, CD-ROM); (iii) recorded lectures given by experts; (iv) situational television, e.g., actors performing to depict day-to-day possible situations and recommended responses; (v) interactive “virtual reality” training; (vi) Q&A on-line training (“Ask the MRO,” “Ask the Lawyer”); (vii) chat room discussions with DER-peers; and the like. It is currently envisaged that delivery of materials may be by both script and streaming video click and play, e.g., through a secure internet website. It is also envisaged that at the Step-2 Module, the DER for employers in regulated industries will be provided: (i) electronic copies of significant or applicable laws or regulations in writing, as well as in searchable CD-ROM, DVD and/or Internet-based navigable formats; (ii) electronic copies of all form documents necessary to maintain compliance. In this manner the instant processes provide a User DER rapid access to answers and materials required for compliance. To ensure that a DER had achieved a proper understanding of professional responsibilities, it is envisaged that the User may be required to demonstrate competence at an optional Step-2 Testing Module, i.e., not resident at the Remote Server, but instead, maintained at the Central Master control processor.

It is also envisaged that a determination of an experience level of a DER may involve periodically reviewing electronic session logs of Training Modules and materials accessed and duration of access, as well as Implementation Modules accesses, duration, and forms and electronic materials processed, i.e., according to stored processor instructions resident in the Central Master Processor Unit at an Audit and Authorization Module and at a Certification Module.

Step 3. Employee Awareness and Substance Abuse Training:

The instant invention provides that the foundation for a more effective and legally defensible drug and alcohol testing policy is based in proof of employee awareness in the drug-free workplace policy adopted by an Entity, and in proof that a substance abuse training program has been implemented. According to the instant processes, a DER User issues instructions at a User Interface to access employee training materials stored at a Step-3 Training Module, i.e., in a Remote Server. A Step-3 Session Log is maintained to follow at least the materials accessed and duration of access, i.e., for subsequent audit, authorization and certification. A Step-3 Implementation Module is used to deliver a checklist comprising a step-by-step set of instructions a recommended to the DER for conducting an employee training session. Optional electronic training materials that may be accessed for employee training at the Step-3 Training Module include, e.g., commercially available and customized videos, CD ROMs, DVDs, on-line internet training, and the like. All employees would preferably view a presentation containing most or all of the following topics: (i) an explanation of the drug-free workplace program; (ii) the dangers of illegal drug use; (iii) the effects of drugs on the brain and body; and (iv) substance abuse resources available for rehabilitation. Preferably, the latter training session is administered by the DER, (i.e., trained in Step-2 supra). During the latter awareness training session, the DER is preferably provided at the Step-3 Implementation Module with the following electronic materials convertible to hardcopy documents for distribution to employees: namely, (i) a copy of the Entity's “policy statement” (i.e., formulated in Step-1, supra); (ii) a list of drugs of abuse for which testing will be conducted along with written information on their adverse effects; and (iii) substance abuse rehabilitation resources. Commonly, for current employees implementation of a new drug-free workplace program will involve a waiting period of about sixty (60) days, i.e., to provide adequate opportunity for compliance, followed by a period of random drug testing. New or prospective employees are commonly tested immediately. Following employee training, employees are preferably required to: (i) sign a consent and acknowledgment form (i.e., processed at the Remote Server and down-loaded in Step-1, supra); and (ii) complete a brief electronic (or written) questionnaire whose purpose is to reflect (for future use) that the individual has understood the major components of the Entity's drug-free workplace program. Electronic copies of consent forms and questionnaires are preferably maintained in an Entity/User database at a Central Master Control processor, with optional electronic duplicate files stored at the Entity's User Interface or at the Remote Server. In the case of written documentation, it is presently preferred that hardcopies are maintained in personnel files, but also, that a scanned copy is submitted electronically for archiving, e.g., in an Entity/User database file at a Central Master Control processing unit, i.e., as set forth hereinabove. According to the instruction provided herein, it is understood that legal benefit is accrued from the providing, and documenting, of extensive employee instruction, in that, by acquainting all employees in an organized and consistent manner with the Entity's drug policy, the testing requirements and the enforcement provisions an employee's ability to claim either surprise, or unfairness, or lack of understanding of policy is dramatically reduced. As a matter of design, it is therefore intended that the instant processes will encourage employees, if only in their self-interest, to make themselves compliant with the Entity's drug free workplace policy.

Step 4. Supervisor Training

The instant invention provides that the foundation for a more effective and legally defensible drug and alcohol testing policy is based in proof of supervisor training in the drug-free workplace policy adopted by an Entity. Training of supervisors in techniques for recognition and handling of employees who may violate an Entity's drug-free workplace policy is believed to be critical to implementing the instant drug-free workplace program. Training of Supervisors is preferably directed by a Step-4 Training Module where access is provided to custom and commercially available videos, CD ROMs, DVDs, on-line streaming audio and video and the like. Activity of the Supervisor at the Training Module is recorded in a Step-4 Session Log, i.e., for later audit, authorization and certification. In alternative embodiments, supervisor training may be provided by the DER. In this case, the Step-4 Training Module contains instruction course outline and materials necessary for the DER to deliver the training to the Supervisors. In the latter alternative embodiment, the Step-4 Implementation Module may contain electronic copies of worksheets, tests and other instructional materials necessary for the DER to deliver training to the supervisors. Preferably, the instant Implementation Module contains materials useful for training supervisors in the techniques of recognizing substance abuse including at least the common signs and symptoms, as well as, the methods for effectively handling employees found to be in violation. The Implementation Module also preferably contains materials useful in training Supervisor's in useful methods for confronting an employee, as well as, methods useful in dealing with possible violent confrontation. Preferably, the Implementation Module additionally provides teaching aids such as scripts useful in role-playing and a supervisor query-response-driven electronic reference aid and toolkit, e.g., recorded in a PDA. In one optional embodiment, proof of Supervisor training and understanding is preferably verified by completion of one or more electronic questionnaires at an electronic Step-4 Testing Module, i.e., located at the Central Master Control processor. Alternatively, electronic form test documents may be downloaded by the DER, printed and subsequently issued by the DER for completion by supervisors. Preferably, hardcopy documents are converted to, and stored as electronic documents. In one alternative embodiment, grading and evaluation of the supervisor examinations and performance is conducted by DER, however, preferably, the instant activity is conducted electronically and a session record is kept for future audit, authentication and certification. Preferably, grading supervisor performance occurs in an interactive session between the DER and a Step-4 Testing Module located at the Remote Server, wherein pre-programmed queries are directed to the DER in an attempt to both document the performance capabilities of the different trained Supervisors and to identify possible areas for future improvement. The activities conducted in the Step-4 Modules are audited and authenticated (in the Audit-Authentication Module) with findings referred to the Certification Module, e.g., as in Step-3, supra. The electronic documents and evaluations processed in Step-4 are preferably stored (e.g., archived) in an Entity/User file, and most preferably the subject file is maintained at the Central Master Control processor unit. For certifying employer compliance in regulated industries it is presently preferred that Supervisor training take place, and be verified, at least two (2) times per year. It is envisaged that the Step-4 implementation module may also contain electronic files and documents designed for this periodic function, e.g., documents printable as paycheck stuffers, electronic files useful as refresher courses. Alternatively, the Step-4 Implementation Module may provide links to refresher materials located on CD-ROM, DVD, internet, intranet, and the like. Results of electronic and/or hard-copy testing, refresher courses and the like, are preferably archived (supra) for possible future use e.g., in certification or in the event of an adverse action review.

Step 5. Collector Selection:

The instant invention provides that the foundation for a more effective and legally defensible drug and alcohol testing policy is also based in collection of test samples by trained personnel, e.g., at an on-site or off-site qualified and/or certified collection center. Examples of training for personnel at the subject collection center include at least recognition of: suspicious behavior, adulterants, visual and sensory signs that a sample may be adulterated, sample handling requirements to maintain chain or custody in regulated industries as well as, handling of possible violent human behaviors. Responsibility for insuring that collection requirements are being met, either on-site or off-site, ultimately resides with the DER. According to the instant methods, for on-site or off-site collection the DER is provided training at a Step-5 Training Module. The training preferably identifies for the DER the key issues to consider in selection of a qualified collection center, or in establishing and maintaining an on-site collection center. In a Step-5 Implementation Module, the DER is provided a checklist and access through a dial-up connection, intranet or secure internet, to lists of qualified, and/or State or Federal certified, off-site collection centers, as well as secured access to an Auction Site where off-site Collection Centers and on-site Service Providers may bid for the DER's business, i.e., the subject Auction Site being administered through and secured by the Central Master Control processor. Representative collection centers include private for profit corporations and contractors (i.e., individuals, partnerships and the like engaged in the off-site and on-site collection of medical samples for doctors, physicians and hospitals), as well as certain contractors specializing in collection of samples for testing drugs of abuse. Representative biological specimens suitable for collection in this manner, and subsequent drug testing, include at least samples of urine, breath, hair, nails, sputum and sweat.

There are currently no national, or international, standards for collection of samples for drug testing, thus, practices vary widely. Current State and Federal regulations mandate specific steps that must be followed in the drug testing collection process, but do not mandate certification. Several independent United States national certifying organization exist. It is understood that this may change in the future and that regulatory requirements may be implemented for certification of collection sites and service providers nationally, as well as internationally. In presently preferred embodiments, the Step-5 Training and Implementation Modules provide the instruction and tools to ensure that the DER understands what to seek from an off-site collection center and/or an on-site contractor, as well as, how to guard against possible adulteration and chain-of-custody issues that may arise during the collection process. Representative examples of instructional materials include those developed by United States, and international, certifying organizations. Links to certifying organizations, e.g., internet, intranet or dedicated lines or data networks, may be used to provide additional instructive materials, as well as, lists of member organizations. In other preferred embodiments, the Step-5 Training and Implementation Modules provides instructional and checklist materials needed to establish an on-site collection center, (i.e., at an Entity-site), along with guidance and direction in how to implement an on-site diagnostics screening program using one or more commercially available diagnostic test devices. In this context, it is understood that the purpose of “screening” shall be to identify those test samples and/or personnel who require additional follow-up collection and/or confirmatory testing, i.e., at an off-site collection facility and/or diagnostic testing facility. For purposes of on-site screening, the instant Step-5 Training and Implementation Modules may include training materials for Entity-personnel involved in collection and/or diagnostic screening of samples at the Entity-site, as well as, special confidentiality requirements, chain of custody issues and the like resulting therefrom. Representative examples of additional instructive materials that may be made available to the DER at the Step-5 Training and Implementation Module include listings of available on-site diagnostic device manufacturers, information relating to functional characteristics of assays, as well as, performance data relating to assay specificity, sensitivity, precision, accuracy, pricing, training requirements and the like.

Step 6. Regulations And Incentives Made E-Z:

The instant invention provides that the foundation for a more effective and legally defensible drug and alcohol testing policy is also based in regulatory compliance with essential established legal principles including collection site requirements, chain of custody issues, adulteration issues, MRO and lab reporting issues and the like. The latter principles, while subject to interpretive changes in the Courts, provide basis for regulatory and insurance guidelines. Representative mandatory binding regulatory guidelines include those set forth in 49 CFR Part 40 (Part 40), i.e., adopted by the United States Department of Transportation for all drug and alcohol testing. Representative insurance guidelines include those mandated by workers compensation insurance companies, i.e., as incentives for reduced premium payments.

The Step-6 Training Module preferably comprises materials useful for instructing the DER in applicable regulations, pitfalls and legal consequences of mistakes. The Step-6 Implementation Module preferably comprises materials useful to the DER for insuring that the proper steps are taken to avoid those pitfalls and mistakes, e.g., a step-by-step checklist. Other representative materials in the Step-6 Training Module include various links to State and Federal regulatory organizations and policy centers, as well as, interactive chat-rooms, on-line guidance from consultants, MROs and lawyers and access to fee-for-service electronic consultants, MROs and lawyers. In certain alternative embodiments, the subject Step-6 regulatory, training and implementation information comprises digital materials and instructions stored at a PDA User Interface in user-accessible files, (e.g., in ROM, data-chips, mini-disks and the like). The latter PDA User Interface is intended to provide portability and ease of rapid access to regulatory and insurance guidelines information. Accordingly, in the instant methods as applied in this manner provide rapid ease of access and a uniformity of information access to legal interpretative materials for collectors, MROs, DERs, diagnostic test laboratory personnel and the like. Considering file limitations in current PDA User Interfaces, it is envisaged that a variety of segmented file structures may be used to deliver the subject materials to a User and that local secured wireless access (e.g., through an on-site portal) may be used to deliver supplemental materials to a User in the field.

Step 7. Selection Of A Test Laboratory:

The instant invention provides that the foundation for an effective and legally defensible drug and alcohol testing policy is also based in selection of a drug testing laboratory. In certain alternative embodiments, one or more on-site, or point-of-collection, screening assays (e.g., an immunoassays) may be used, supra, and such case only the samples testing positive are referred to the diagnostic test laboratory, i.e., for confirmation.

Ultimately, the DER is responsible for implementing the effective and legally defensible drug and alcohol testing policy. Therefore, the Step-7 Training Module comprises information useful to the DER in selecting a test laboratory and the Step-7 Implementation Module comprises information useful for the DER for avoiding common pitfalls and mistakes, e.g., a step-by-step checklist. Certain state regulations may require use of certified testing laboratories, and where this is indicated, (i.e., according to information provided by the User in Step-1, supra), the Step-7 Training and Implementation Modules may provide customized materials useful for ensuring ease of compliance with such requirements. Representative materials at the Step-7 Training Module also comprise materials useful for selecting a type of biological specimen for collection and testing. As set forth supra, a variety of different biological specimens may be suitable for testing. However, the test results obtained from these different specimens currently have differing legal values. Preferably, the contents of the Step-7 Training Modules contain interpretive considered advice in regards to the legally defensible use of different types of samples and test laboratories, as well as, information on how best to use point-of-collection screening assay devices, i.e., all in view of the applicable State and Federal regulations as they may be applicable to the Entity. The Step-7 Training Module may also include e.g., as relevant, information regarding the accuracy and reliability of various drug test assays (e.g., sensitivity of different drug test assays, identification of assays that may be considered unreliable or more subject to employee challenge, incidence of “false positives” or “false negatives” associated with various drug test assays that may make them undesirable for particular applications, etc.). By identifying to the DER potentially-undesirable drug test assays, this component of Step-7 Training Module may reduce the likelihood of employee challenges or actual or asserted legal liability based upon disciplining an employee in connection with an inappropriate or low-confidence assay method. Representative instructive materials useful to the DER in the Step-7 Training Module may include e.g. descriptions of the assay methods employed, the possible risks associated with different types of testing, the ways in which samples may be adulterated, the methods commonly used for validation of sample integrity (e.g., creatinine levels), and the like. Other representative materials potentially useful in the Step-7 Training Module include internet and intranet chat rooms, question and answer and discussion forums, and the like designed to create a website-based community resource for the DER. The intent of providing such resources is to improve performance of Test Laboratories (and point-of-collection devices) by allowing DERs to exchange information as to impressions of the level of service, responsiveness and support received from the respective different test laboratories and device manufacturers.

Representative materials at the Step-7 Implementation Module include digital lists of test laboratories such as e.g. the ninety (90), or more, commercial drug testing laboratories in the United States certified by SAMHSA, i.e., a non-governmental organization of laboratory administrators. Certain test laboratories may specialize in urine testing, others in saliva testing, still others in hair testing, and yet others in sputum. The latter laboratories utilize good laboratory practices (GLP) and FDA regulated diagnostic assays as a first step in detecting drug analytes in biological samples; then, where indicated, the presence of a drug analyte in the sample may be confirmed using a sensitive laboratory analytical assay, e.g., tandem GC/MS.

Additional representative materials in the Step-7 Implementation Module include one or more electronic links and/or one or more digital lists effective to connect a DER user with: (i) one or more diagnostic test laboratories; and/or, (ii) where indicated by the regulatory status of an Entity, (i.e., Step-1 supra), electronic links and digital lists to certified laboratories. In both of the latter cases, additional Step-7 information supplied to the DER user preferably includes e.g. descriptions of the type of testing conducted, the possible legal admissibility and/or regulatory usefulness of the results obtained, as well as, contact information and pricing, i.e., as available. In certain presently preferred embodiments, the subject Step-7 Implementation Module comprises a Step-7 Auction Module, i.e., enabling a digital DER listing of services required and entry of competing bids by interested service providers and test laboratories. The latter Step-7 Auction Module preferably allows on-line (i.e., internet, intranet or dedicated network) trading between buyers and sellers of drug testing services, as well as, on-site diagnostic test devices.

While the instant Step-7 Implementation Module may be effective to establish a user-client relationship between a DER and a diagnostic testing facility, the instant methods impose limitations on the data that will be provided from that laboratory to the DER. As set forth further below, according to present practice, a DER will not commonly have unrestricted access to the results of drug testing. Instead, presently preferred practice dictates that drug test information is reviewed by a Medical Review Officer (MRO). Should a subject exhibit a positive drug test, the MRO has responsibility for determining whether there is an alternative medical reason that may account for the test result. Accordingly, the MRO has responsibility for properly informing the DER. As set forth below, embodiments of the invention provide secure methods for a remote off-site MRO receive test data from a laboratory, review the data, communicate with employees and DER, and in general, service the multiple needs of a number of different related and un-related client business interests.

Step 8. Random Selection Of Test Subjects:

The instant invention provides that the foundation for an effective and legally defensible drug and alcohol testing policy is also based in random and impartial selection of subjects, i.e., employees, for testing. The Step-8 Training Module comprises instruction in the legal need for random selection and the scientific/mathematical basis for random selection as provided, according to the Step-8 Implementation Module. For compliance, in certain regulated industries Entities may be required to periodically test up to fifty percent (50%) of employees. In other situations, regulated Entities may be audited to determine that they are in compliance, and in certain situations noncompliance may result in a fine.

The Step-8 Implementation Module preferably comprises methods for ensuring that test subject selection is random, e.g., by secure random mathematical selection at a Central Master Processor or at a Remote Server. The Step-8 Implementation Module also preferably comprises means for a DER to enter data indicating which employees are to be subject to random testing. When necessary, confidentiality of the subject data (comprising digital data) may be maintained e.g., by bar coding, digital encryption and the like. Preferably, the subject information is transmitted to the Central Master Processing unit where it is stored in one or more Entity/User files. Most preferably, the instant Step-8 Implementation Module comprises means for a test laboratory to submit test results to a Central Master Control processor unit and for an MRO to access data stored at that site. Most preferably, the subject test results are digitally recorded and processed by instrumentation in the test laboratory, and when validated, are transmitted independently from the test laboratory for storage in one or more Entity/User files at the Central Master Control processor.

In other embodiments, the invention provides electronic methods for establishing compliance with: (i) random selection requirements, while minimizing the possibility of human interference; (ii) transmittal of test results while also minimizing the possibility of human interference; and, (iii) requirements for independent review and evaluation of the random selection process. The subject compliance review is conducted according to the instant invention by reviewing and evaluating the random selection and test data stored in Entity/User files, supra. In yet other embodiments, the invention provides methods for electronically auditing regulatory compliance by evaluating data stored in Entity/User files to make a determination of (i) whether random selection was employed; (ii) whether the employees asserted to have been submitted for testing conform to the test sample results reported by the test laboratory; (iii) whether follow-up action (as set forth below) was taken in regard to samples reported as testing positive for one or more substances comprising drugs of abuse. In still other embodiments, the invention provides methods for electronically auditing the performance of a DER implementing a random selection and testing program at an Entity through a process involving evaluating and judging the content of Session Logs, stored in an Entity/User file, and comprising the actions, queries and responses of the DER at the Training and Implementation modules set forth in Step-1-through-Step 8 , supra.

Representative instructive stored materials in the Step-8 Training Module include materials helpful to the DER in personnel conflict resolution, useful signals in identifying possible future problems and the like. Additional electronic and digital materials may include CD-ROM, DVD and/or access to one or more on-line policy centers, e.g., through secured internet or intranet connections.

Step 9. Test Subject Privacy Human Rights Guidelines:

The instant invention provides that the foundation for a more effective and legally defensible drug and alcohol testing policy is also based in maintaining personal privacy of test subjects as well as the integrity, accuracy, and confidentiality of drug testing results. The Step-9 Training Module comprises digital and electronic processes designed to educate the latter requirements. Representative materials at the Step-9 Training Module include digital lists of “Dos-and-Don'ts”; streaming audio and video, CD-ROM and DVD presentations conveying interactive and/or situational role playing; policy statements conveying limits of allowable conduct; and the like. Also provided in the latter Step-9 Training Module, are possible secured connections with peers and advisors e.g. in chat-room settings, as well as, access to stored digital informational materials such as periodically uploaded by consultants, MROs, lawyers and the like. The representative materials at this Training Module may also include processor-driven interactive guidance on handling of different situations, e.g. how to discuss test results with employees and supervisors, as well as, controls necessary to maintain a “need-to-know” security system. Also included in this Module may be digital information relating to dealing with asserted bias, dealing with employee requests for copies of reports, evaluating and responding to questions or challenges as to accuracy, reliability, or integrity of the results of a particular drug assay method, dealing with possible employee refusals to submit to testing and resulting disqualifications under unemployment compensation and workers compensation (wizard toolkit), guidance on retention of records and only releasing information to those who have an absolute need to know and the like.

The Step-9 Implementation Module comprises checklists and methods for maintaining control of privacy at each of the prior Steps (supra), in this case, throughout the processes of: (i) selection of a test subject; (ii) collection of a test specimen; (iii) drug assay testing on-site or off-site; (iv) processing on-site or off-site test data at an on-site or off-site location; (v) reporting of the test information to an MRO, a DER, an employee, or a supervisor at the Entity, as well as methods for insuring chain of custody for possible challenges. Where the Entity has identified an on-site or an off-site MRO, the instant Step-9 Implementation Module provides digital instructions on the limitations of access imposed on the DER, as well as, the functions of a secure encryption-protected portal and methods whereby the MRO may download drug test information from a drug test laboratory and whereby the DER may communicate with the MRO concerning the drug test results received and evaluated by the MRO. Representative examples of the subject confidentiality methods include secure computer-controlled random-keyed bar coding of employee test samples such that only the computer initially “knows” the identity of the test subject and laboratory test results and then only the MRO has the access keys to decipher the results. Representative examples of methods useful for “keyed” coding of test samples is wide-spread in the art of pharmaceutical clinical trials drug testing, but has not (to the inventors' knowledge) been applied in a workplace setting for random testing for drugs of abuse. In certain preferred embodiments, the Step-9 Implementation Module comprises guidance and processing instructions allowing an MRO to download laboratory results and prepare electronic reports, and for a DER to download those MRO reports. Also included are processing instructions and secure sockets allowing a DER to consult with the MRO (e.g., via secured Email), then seek advice of legal counsel consultants and the like in regards to various human rights issues. Where appropriate, the Step-9 Implementation Module may also provide secured socket connections allowing correspondence with State and Federal regulatory agencies, insurance providers and the like. The subject test results, MRO reports, legal advice of counsel and the like preferably comprise digital records stored by electronic means, i.e., any written materials are preferably scanned to create digital documents for electronic storage. The subject digital records are preferably filed and maintained at an electronic site which is separate and apart from other corporate records, and particularly separate from personnel files and the like. Preferably, the activities of the DER at the Step-9 Testing and Implementation Modules are preferably audited, authenticated and certified, and because of the importance of protecting human rights, an optional on-line electronic questionnaire may be used as additional authentication for completion of training at the Step-9 Training Module. Preferably, following completion of training any activity of the DER at the Step-9 Implementation Module is audited and the Session Logs are reviewed periodically by a human and/or an electronic auditor programmed to evaluate the materials accessed by the DER, i.e., by reviewing Session Logs stored at an Entity/User file at a Central Master Processing unit. Digital audit data is preferably used as one component of an electronic process for certifying the drug free workplace status of an Entity.

Step 10. Process for MRO Review:

Ultimately, the DER is responsible for all aspects of drug testing an review for an Entity. Despite direct MRO intervention in this process, i.e., as the first line of medical review, it is important that the DER understand fully the duties, responsibilities and activities of the MRO. At a Step-10 Training Module the DER is made aware of the required role of a Medical Review Officer. As used herein, “Medical Review Officer,” abbreviated MRO, is intended to mean a Medical Doctor (MD), Doctor of Osteopathy (DO), and any other recognized technically qualified Health Care Practitioner who is legally authorized to act as a reviewer of test data, a consultant and/or an advisor to an Entity (as discussed hereinabove) in regard to testing for drugs of abuse and alcohol. Representative digital training materials stored in files at the Step-10 Training Module include: (a) instruction materials relating to the legal limitations placed on a DER not to interpret a laboratory drug test result; (b) instruction materials relating to the legal role of an MRO in evaluating of laboratory test results; (c) instruction materials relating to the legal and medical responsibilities of an MRO in regard to medical evaluation of laboratory reports; (d) instruction materials relating to responsibilities of an MRO for determining whether an alternative medical explanation may exist for a “positive laboratory test result,” i.e., understood herein as a report indicating the presence of a drug or alcohol analyte in a test sample collected from a test subject; (e) instruction materials relating to the responsibilities of an MRO for making a determination of the suitability (or unsuitability) of the test specimen as collected, e.g., interpreting the results of a validating assay (defined supra).

According to the methods of the invention, it is anticipated that MRO training and certification, and/or continuing education, could be delivered using the instant processes with audit, authentication and certification of completion. However, at present, MROs are commonly certified by two national organizations after completing a course of study with qualifying examinations. Given the specialized nature of this training and the relatively limited number of individuals so trained, it is presently considered unlikely that many small and medium-sized employers could justify the cost of retaining the full-time services of an MRO. Thus, at a Step-10 Implementation Module, the DER is provided a checklist and secured access, (e.g. through a dial-up connection, Intranet or secure Internet), to individual consultant MROs, as well as, to organizations of MRO service providers. Preferably, at the Step-10 Implementation Module a DER user is provided access to a secure MRO Auction Site, i.e., administered by the Central Master Processor, where the subject user may (i) post the nature of the services required and a request for bids; (ii) where certified MRO Service providers may respond; and, (iii) where the DER user may select an MRO and then establish a contractual fee-for-services relationship.

Accordingly, embodiments of the invention provide electronic processes at the Step-10 Implementation Module for one or more of the following: namely,

(i) an Entity to select an MRO and retain same on a consulting (fee-for-service) basis, i.e., consisting essentially of digital lists of consultants, links to consultant websites, on-line secure auctions for services and on-line secure links for negotiating terms and conditions under which MRO fee-for-services will be provided;

(ii) a DER and an MRO-consultant to setup a secured electronic means for future interchange of employee/test subject information, laboratory reports and the like;

(iii) a DER and an MRO-consultant to setup a secured electronic means for future conferring, as needed, in a secure manner regarding possible positive laboratory test results while respecting patient confidentiality, e.g., including at least secure on-line, internet and/or intranet communications; optional streaming audio and/or video; as well as, possible digital televideo communications;

(iv) a DER to setup a secured electronic means for an MRO service provider to (in the future) take medical histories and conference with employees in a confidential manner, such that the MRO may obtain medical information necessary to determine whether there may exist an alternative medical explanation for a future possible positive laboratory test result, e.g., secure means including at least secure on-line, internet and/or intranet communication; optional streaming audio and/or video; as well as, possible digital televideo communications;

(v) a DER to setup a secured electronic means for an MRO service provider to consult (in the future) in regard to possible specimen adulteration, substitution, validating assays, and/or additional testing standards and issues; and,

(vi) a DER to setup a secured electronic means for an MRO service provider to consult in a secure manner (in the future) in regard to positive and negative laboratory drug test results.

In one presently preferred embodiment, (i.e., required in certain regulated industries), an Entity, through actions of its DER, selects a permanent on-site or off-site MRO, or an MRO service provider, who reviews all laboratory test results and withholds reporting of all positive test results until the MRO has ascertained that no alternative medical explanation exists for the positive test result. It is anticipated that in certain unregulated industrial settings certain Entities may prefer not to retain an MRO service provider as a full time consultant, but instead may prefer to use those services only when a positive test result is under consideration. Under these circumstances it is anticipated that negative laboratory test results may be released directly to the DER, with only positive results being referred to the MRO service provider. It is also envisaged that, to preserve confidentiality, this may require staggered and/or delayed release of negative test results so as to disguise the delayed reporting associated with a possible positive test result. Thus, it is anticipated that the Setup process in Step-1 may accommodate certain Entity-customized activities in the Step-8, Step-10 and/or Step-11 Training and Implementation Modules, e.g. conditioned by the regulatory status of the Entity and options requested by the User in the Step-1 Setup.

As set forth supra, in situations where the DER (and Entity) selects a permanent on-site or off-site MRO service provider to review all laboratory test results and act on behalf of the Entity, in presently preferred embodiments, (illustrated in FIG. 1), electronic provision is made for (i) a DER to securely designate such MRO; (ii) for the MRO so designated and securely electronically identified, to be provided access through independent access channels to secure and/or encrypted laboratory test results, i.e., such results as were stored in the Entity/User file in Step-8, supra; and, (iii) for the MRO to issue digitized reports through secure electronic means to the DER summarizing his/her findings.

Step 11. Process for Substance Abuse Referral:

In receipt of a summary report from an MRO service provider (i.e., according to Step-10, supra), and the finding of a positive laboratory test result, the DER is responsible for taking appropriate actions. At a Step-11 Training Module, the DER is instructed, (according to current applicable regulations and Federal and State statutes), as to the role of a Substance Abuse Professional Consultant and applicable requirements for referral of an employee to rehabilitation. Most regulated drug free workplace programs require referral of an employee with a positive drug test to rehabilitation. The referral is most appropriately processed by a Substance Abuse Professional who evaluates the employee and then recommends a course of treatment. Regulations may also commonly require proof of rehabilitation before the subject employee may be returned to regular employment, regulated duties and/or service.

At the Step-11 Implementation Module a DER is provided with secure access to trained Substance Abuse Professionals (offering fee-for-service consulting), i.e., according to the same processes, methods, and types of on-line lists, links, auctions, negotiations and the like as are described above in regard to selecting and setting up communications with an MRO service provider (Step-10, supra). A secure on-line community chat room is also provided allowing a DER access to peer-level discussions of the types and qualities of different consultant services, e.g., consultant responsiveness and the like.

In certain presently preferred embodiments, where the DER electronically selects a Substance Abuse Professional, electronic provision is made for (i) a DER to securely designate such Substance Abuse Professional; (ii) for the Substance Abuse Professional so designated and securely electronically identified, to be connected with the DER through a Central Master Control processor which oversees and records the substance of the communications. Most preferably, as illustrated in FIG. 1, the Substance Abuse Professional is provided an independent “Consultant Interface” and a secure and/or encrypted access channel through the Central Master Processing Unit to the DER.

Step 12. Process For Adverse Action Review:

In receipt of a summary report from an MRO service provider (i.e., according to Step-10, supra), and the finding of a positive laboratory test result, the DER is responsible for taking appropriate actions to reduce risks to fellow workers and the public. A Step-12 Training Module provides guidance for a DER in regard to the issues and methods for reaching a defensible Adverse Action Decision, i.e., intended to mean a decision in which an employee is relieved of work responsibilities and referred to rehabilitation services (i.e., Step-11, supra). After an MRO has interviewed the subject employee, (i.e., either using an in person interview or the electronic means provided herein), and also after any additional follow-up testing or physician physical examinations have been completed and results evaluated, then when the findings still indicate that no alternative medical explanation exists for the positive laboratory drug test result, then it is commonly incumbent on the DER, (in consultation with the MRO and any legal counsel for the Entity), to conduct an Adverse Action Review. Digital instruction materials provided to the DER at the Step-12 Training Module include those directed toward setting forth in clear and decisive terms the desirability of retaining counsel, as well as, the legal consequences for taking inappropriate actions, i.e., with the pitfalls and common mistakes. Representative digitized training materials include those providing discussions of issues such as: means for determining test accuracy; means for determining allowable enforcement actions (e.g., set forth in Entity policy); means for rendering action in a consist manner; means for determining appropriateness of documentation; means for evaluating whether the subject employee is eligible for a last chance agreement; means for appropriately considering possible adulteration of samples; means for reviewing an employee's refusal to submit to testing; means for determining the appropriateness of documentation confirming refusals to testing; means for evaluating the quality of recorded digital and/or written documentary evidence of employee awareness with the Entity's drug free workplace policy; and the like.

At the Step-12 Implementation Module, electronic processes are provided for guiding the DER in a stepwise manner through the process of conducting an effective and defensible adverse action review and through the process of reaching an adverse action decision. It is anticipated that the subject adverse action review may be conducted in person, in writing, in teleconference, or in video conference. Preferably, the subject review is conducted using electronic means, e.g., secure channels of communication through a Central Master Processing Unit, so that the transactions may be digitally recorded and filed for future possible audit and/or legal review.

Electronic Processes for Verifying Drug Free Workplace Status:

The electronic audit, authentication and certification process set forth in Steps 1-12, supra, are useful for electronic verification that an Entity, or an Entity-site, is in substantial compliance with the policies and programs required for certification as having a drug free workplace. The latter certification may constitute a requirement response to Federal, State or local regulatory requirements, or to requirements set forth for reduced insurance premiums. Preferably, for a newly compliant Entity the minimal requirements for the subject Entity-certification comprise electronic verification of audit, authentication and certification at Steps 1-4, i.e., verification that Steps-1-4 have been implemented. Preferably, for an established compliant Entity the minimal requirements for the subject Entity-certification comprise electronic verification of audit, authentication and certification at Steps 1-9. More preferably, for an established compliant Entity the requirements for the subject Entity-certification comprise electronic verification of audit, authentication and certification at Steps 1-10. Most preferably, for an established compliant Entity the requirements for Entity-certification comprise electronic verification of audit, authentication and certification at Steps 1-10, supra, along with satisfactory legal review of the appropriateness of actions taken in Step-11 and Step-12.

Electronic Automated Process for Steps 1-12:

The electronic automated processes by which the above-described Steps 1-12 of the instant invention may be carried out can be more clearly understood with reference to the appended Figures, as is explained herewith:

FIG. 1 depicts an illustrative secure automated electronic computer network for carrying out the instant stepwise processes (set forth hereinabove). The representative computer network consists of a User Interface PC 10 and/or a User Interface Personal Digital Assistant 20. Either of the latter two Interfaces is linkable with an optional Remote Server 30 and/or a Central Master Control Processor 40 through either, or several, of the following: namely,

(i) modem 11 connection through telephone company lines 12, or dedicated lines 13, to an Internet Service Provider (ISP) 14, i.e., internet ISP access;

(ii) wireless 21 connection with an Application Service Provider (ASP) 22, i.e., Wireless ASP access; and,

(iii) modem 11 connection through telephone company lines 12, or dedicated lines 13, to an optional Remote Server 30 and/or directly to a Central Master Control Processor 40, i.e., intranet.

In the case of the latter linkages through either an internet ISP or a Wireless ASP, the subject communication is directed through a secure Internet Server 50 to optional Remote Server 30 and/or Central Master Processing Unit 40, referred to hereinafter as CMPU 40. Unauthorized access at Server 30 is made more difficult by Firewall 51. Unauthorized access at CMPU 40 is likewise controlled by Firewall 41.

In a presently preferred embodiment, (for security purposes), the subject User Interfaces 10 and 20 do not directly access Server 30, and also, do not directly access CMPU 40. Instead, all User Interface 10/20 access with CMPU 40 is directed through secure lines first to Firewall 41, then to Server 30 and then to CMPU 40.

According to other presently preferred embodiments, (also occasioned by security considerations), Remote Server 30 comprises databases and processing instructions for the Step 1-12 Training and Implementation Modules 32/33 and related data 34/35, supra, but does not contain any user-sensitive materials, e.g., drug test results, identity of Entities and the like. Instead, user-sensitive materials are maintained at CMPU 40. Representative examples of sensitive materials stored and/or processed at CMPU 40 include at least user data and processing instructions 42; drug test processing instructions and data 43; Entity and DER processing instructions and certification data 44; security processing instructions and data 45; audit processing instructions and data 46; auction processing instructions and data 47 (supra); consultant processing instructions and data 48; and the like.

In yet other presently preferred embodiments, User Interface 10/20 has no direct link with any of (i) a collection center/site interface 70, (ii) a diagnostic test laboratory interface 80, (iii) an MRO consultant interface 90, (iv) a Substance Abuse Profession consultant interface 90 and (v) a Substance Abuse Legal Consultant interface 90. According to the latter provisions, linkage with all five entities is only that which is provided for and controlled through CMPU 40. In this manner it is preferred that CMPU 40 can verify authenticity of all professional personnel involved in communication with a User, and can monitor communications to insure control of the quality, as well as, the legal appropriateness of all of the instruction provided thereby. Communication links with collection site interfaces 70, test laboratory interfaces 80, and consultant interfaces 90 are preferably via dedicated land lines (i.e., telephone company secure circuits), although in alternative embodiments, provision is made for certain secure encrypted communications through Internet Server 60. Firewalls 42 and 61 are intended as protection for CMPU 40 and internet server 60, respectively. In certain alternative embodiments, it is envisaged that security may be enhanced by providing one or more additional remote collection center, test center and/or consultant servers (not depicted in FIG. 1) as additional communication gateways between interfaces 70, 80 and 90 and CMPU 40.

The instant preferred hardware architecture, as exemplified and illustrated in FIG. 1, provides advantages for dissemination of processing and security functions; multiple levels of security access; centralized control of sensitive information; centralized control and oversight of consultations with substance abuse professions; and central audit oversight for security, certification and the like (supra).

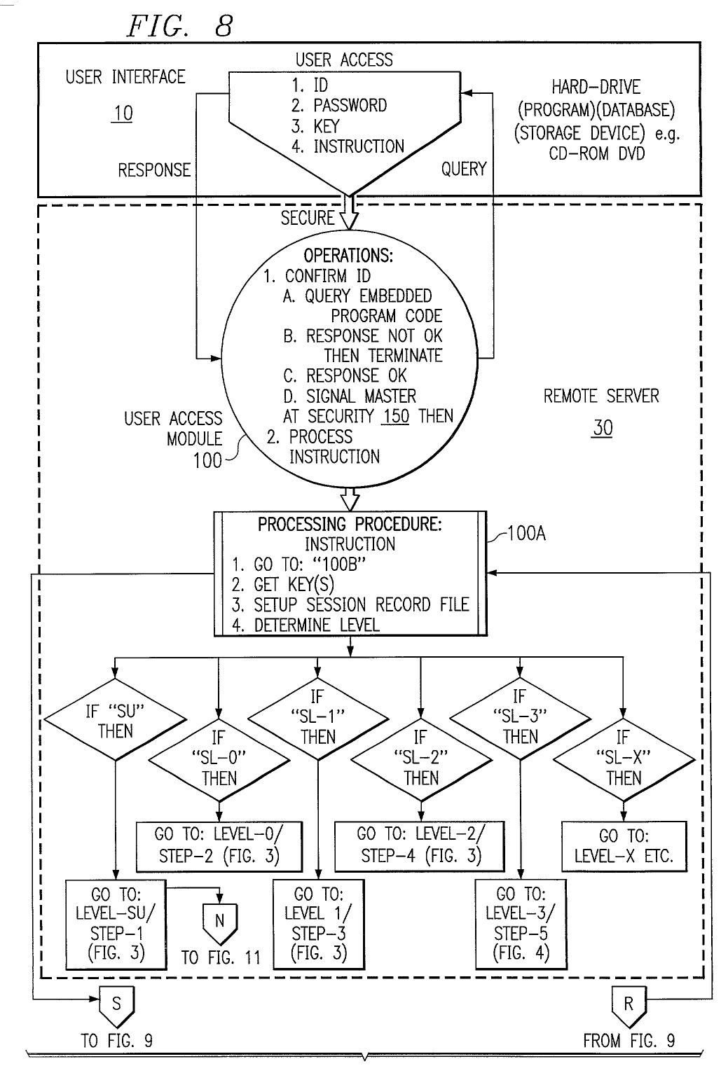

FIGS. 2-4 depicts an illustrative method operative at a central master control processing unit (CMPU) 40 for controlling User/DER access and insuring that the instant stepwise hierarchical processes (set forth supra) are completed in an ordinal manner. Higher level security control is exerted by CMPU 40 over instructions issued by a User/DER at User Interface 10/20 and directed to CMPU 40 through Remote Server 30 (FIGS. 1-2). (Functions of individual User Access Module 100, Security Module 150, User Data Module 160 are disclosed in greater detail below in regard to FIG. 8) According to the instant processes, User Access to instructional materials, i.e., in Training Modules (supra), and to toolkits and checklists, i.e., in Implementation Modules (supra), is controlled in a stepwise fashion by CMPU 40 after review of “Status Level” descriptors issued by a Status Level Module 170 and/or a Testing Module 180. According to the instant processes, as illustrated in FIGS. 2-4, Status Level Module 170 audits and authenticates the session logs maintained by Training Monitor Module 190 and forward the findings to Status Level Module 170 which reviews the findings, makes a determination on the appropriateness of the actions and then issues status level (SL) descriptors which is forwarded, along with the findings, to Certification Module 200. Certification Module 200 reviews the combined “Evidence” for any possible irregularities, and then, if warranted, certifies the findings and confirms the SL designation issued by Status Level Module 170. Representative examples of processing conducted by the Status Level Module 170 to audit and authenticate performance of a user in regard to completion of specific training or tasks, includes, e.g.: (i) comparing the subject User/DER session data at Module 190 to historical norms with respect to training database materials accessed and duration of access; and/or (ii) evaluating questions and answers in interactive sessions conducted at a Training Module; and/or (iii) evaluating tasks completed by assessing materials downloaded to User Interface 10/20.

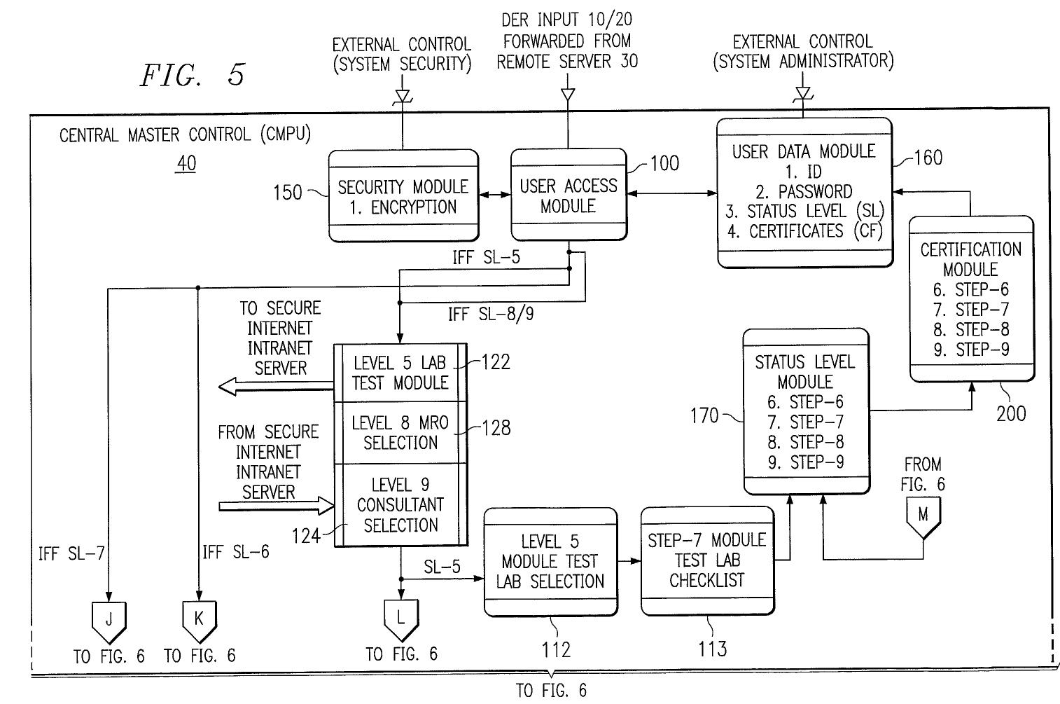

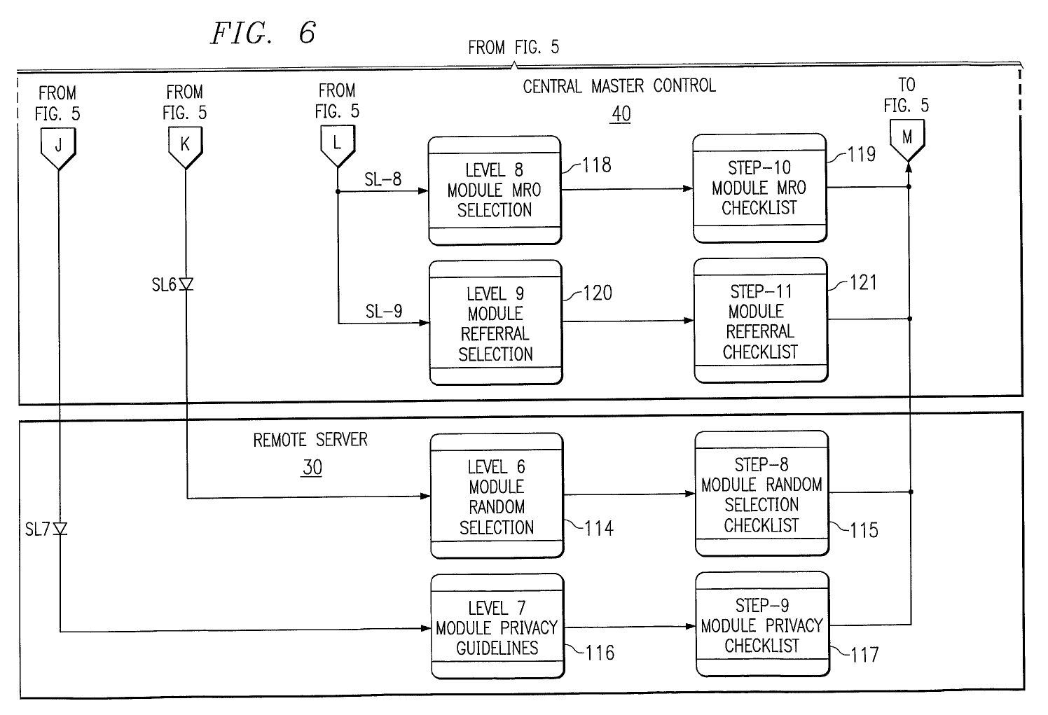

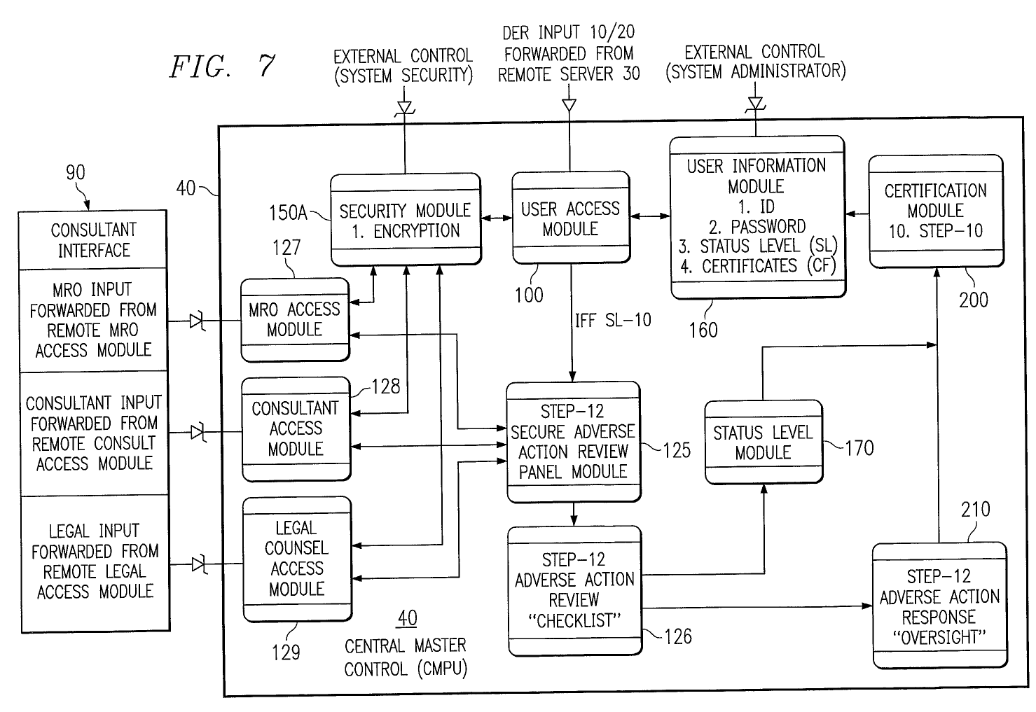

Referring to FIGS. 2 and 3 at “Level SU”, User access begins at a “Setup” (SU) status level (i.e., SL-SU) in Level SU Site/Entity Setup Module 101 where Entity and DER-candidate information may be entered which may be stored in User Data Module 160 for use in subsequent working sessions to confirm identity, e.g., identification number, password, personal information, etc. Completion of information at Module 101 results in access to Status Level-0 (SL-0) instructional materials available in Training Module 102, i.e., directed to initial training of a DER and setting up a drug free workplace policy for the Entity (Step-1, supra). Implementation Module 103A is directed toward setting up a draft drug free workplace policy suitable for review by legal counsel, i.e., Step-1, supra, and Implementation Module 103B is directed toward Step-2, supra, i.e., DER training as set forth further below. Status Level Module 170 conducts audits, authenticates activities and forwards the results to Certification Module 200 (supra), i.e., satisfactory completion of policy Set-Up (Step-1), DER training (Step-2) and/or implementation of any requisite sub-steps therein. If only policy is set-up, Status Level Module 170 then recommends a digital SL-0 designation to the DER/Entity, if both policy set-up and DER training are completed, Status Level Module 170 recommends a digital SL-1 designation for the DER/Entity. In either event, that status level designation is stored for future use in User Data Module 160, i.e., allowing the User/DER-candidate future assess to materials only at the SL-0 level. Unfortunately, because of US PTO formatting standards, the instant sequential process was necessarily broken down into FIGS. 2-4, (i.e., dealing with Steps SU, 1, 2, 3, 4, 5 and 6, as set forth supra); followed by FIGS. 5-6, (i.e., dealing with Steps 7-11) and FIG. 7, (i.e., dealing with Step 12). TABLE A, below, is provided for the use of the reader as an aid to navigation. The Central Master Processing Unit 40 and Remote Server 30 appearing in FIGS. 2-7 is one and the same unit, as is also true for Security Module 150, User Access Module 100, User Data Module 160, Certification Module 200 and Status Level Module 170. While fragmented in the figures, it is intended that in practice the instant process is conducted in a seamless manner, i.e., progressing from Steps 1 through Step 12 in a series of loops with oversight and control being exerted at each loop and Step by Modules 100, 160, 200 and 170. Routes between the respective FIGURES, i.e., to or from, are indicated by pointed pentagonal shapes bearing letter designations, e.g., “A”, “B”, “C”, “D”, etc. FIG. 2. The relationship between the Steps (supra), Training Completed, Implementation Completed and resultant earned User Status Level is also set forth in TABLE A. TABLE A, as read from left to right, shows that with completion of the indicated Training and Implementation the User earns access to the materials at the Status Level indicated in the right hand column. As the User completes all of the training and tasks at one line and earns the indicated Status Level designator, then the User may advance to the next line of TABLE A. Access to each successive next line requires that a User earn the indicated Status Level designation appearing in the far right column of the next higher line in TABLE A.

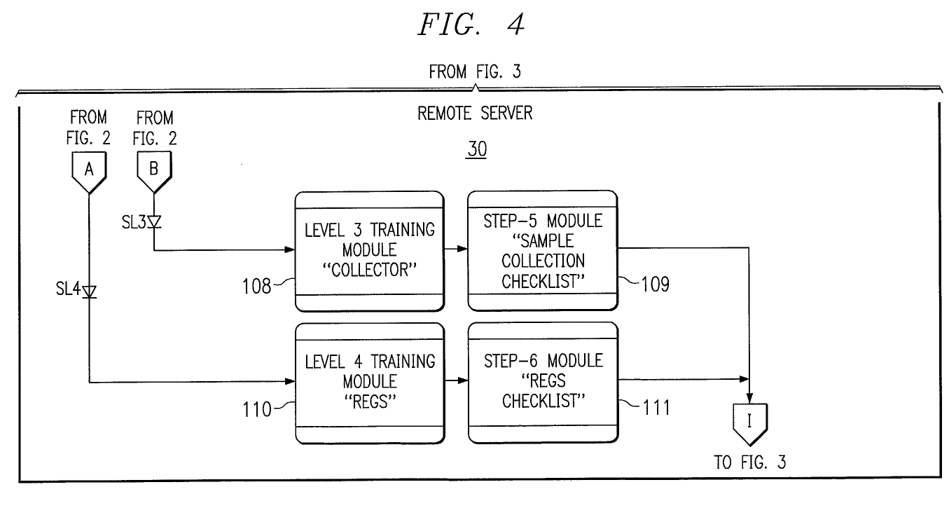

TABLE A
Navigation Guide

| | | | Access: |
|---|---|---|---|
| Step | Training (Module) | Implementation (Module) | Status Level |
| Setup | None | None | SU |
| Step-1 | Policy 102 (FIG. 3) | Policy 103A (FIG. 3) | SL-0 |
| Step-2 | DER Training 102 (FIG. 3) | DER 103B (FIG. 3) | SL-1 |
| Step-3 | Employee Awareness 104 (FIG. 3) | Awareness 105 (FIG. 3) | SL-2 |
| Step-4 | Supervisor 106 (FIG. 3) | Supervisor 107 (FIG. 3) | SL-3 |
| Step-5 | Sample collection 108 (FIG. 4) | Collection 109 (FIG. 4) | SL-4 |
| Step-6 | Regulations 110 (FIG. 4) | Regulations 111 (FIG. 4) | SL-5 |
| Step-7 | Test Lab Select 112 (FIG. 5) | Lab Select 113 (FIG. 5) | SL-6 |
| Step-8 | Random Test 114 (FIG. 6) | Random Test 115 (FIG. 6) | SL-7 |
| Step-9 | Privacy 116 (FIG. 6) | Privacy 117 (FIG. 6) | SL-8 |
| Step-10 | MRO Selection 118 (FIG. 6) | MRO Selection 119 (FIG. 6) | SL-9 |
| Step-11 | Consult Select 120 (FIG. 6) | Consult Select 121 (FIG. 6) | SL-10 |
| Step-12 | Adverse Action 125 (FIG. 7) | Action Review 126 (FIG. 7) | SL-11 |

At “Level 0”, FIG. 3, training provided to the User/DER e.g. by repetitive User accessing of SL-0 level materials stored at Training Module 102 is effective and sufficient to enable a User/DER-candidate to achieve successful audited, authenticated and certified performance of training at Implementation Module 103B and/or to pass any necessary or optional qualifying examination at Testing Module 180, (i.e., training activities effective to satisfy compliance with DER training at Status Level Module 170 and Certification Module 200). Audited, authenticated and certified digital proof of satisfactory completion of DER Training and Policy Set-Up is stored in the User Data Module 160, i.e., the subject certification being effective to next allow DER access (but only certified DER access) at the SL-1 level in subsequent working sessions.

At “Level 1”, FIG. 3, training is provided in Training Module 104 sufficient to enable a DER to perform the activities set forth in regard to Step-3, “Employee Awareness and Substance Abuse Training,” supra. At Implementation Module 105 DER activities in Training Module 104 are audited and authenticated and, optionally, the DER is provided additional digital authentication materials, e.g. checklists and/or questionnaires such as may prove effective in providing Evidence to Training Monitor 190 and/or Status Level Monitor 170 of satisfactory implementation at Step-3. Certification, and/or digital evidence being found satisfactory, the Status Level Monitor 170 accords to the DER the next higher access level, i.e., SL-2.

At “Levels 2-4”, FIGS. 3-4, training is provided in a stepwise fashion in Training Modules 106, 108 and 110; tasks are completed in Implementation Modules 107, 109 and 111, Training Monitor 190 oversees user activities and directs the sequential course of instruction comprising the digital curriculum, Testing Module 180 (FIGS. 2-3, “H”) administers any required tests and/or questionnaires, Status Level Module 170 (FIGS. 2-3, “G”), audits and authenticates the activities of the DER and, if appropriate, recommends sequentially increased SL designations to Certification Module 200 (FIG. 2), i.e., resulting in stepwise DER access first to SL-3 (FIG. 2, “B”) and then SL-4 (FIG. 2, “A”) materials.

Referring to FIGS. 5-6, “Levels 5-9” illustrative means are depicted for training a DER in the aspects required for: (i) selection of a test laboratory (Training Module 112 located at CMPU 40; FIG. 5); then, (ii) random selection of an employee for testing (Training Module 114 located optionally at Server 30; FIG. 6); then, (iii) maintaining privacy during testing (Training Module 116, also located optionally at Server 30; FIG. 6); then, (iv) selection of an MRO (Training Module 118 located at CMPU 40; FIG. 6); then (v) selection of a substance abuse professional consultant (Training Module 120, also located at CMPU 40, “Referral”; FIG. 6). As indicated, the process is conducted sequentially and following training at each step an implementation module is provided with checklists to insure satisfactory completion (i.e., at Implementation Modules 113, then 115, then 117, then 119, then 121). Auditing and authentication of satisfactory completion of the Steps 7-11 (113, 115, 117, 119, 121, FIGS. 5-6) is performed by Status Level Module 170 (FIG. 5; “M” FIG. 6). Evidence from auditing and authentication being satisfactory, Status Level Monitor 170 sequentially recommends and Certification Module 200 issues the DER access to SL-5 (FIG. 5), then SL-6 (FIG. 6, “K”), then SL-7 (FIG. 6, “J”), then SL-8 (FIG. 6, “L”) and then SL-9 (FIG. 6, “L”) materials.

Where secure communications with a Test Laboratory, MRO, Consultant or Legal counsel is advisable, e.g., in the process of electronically selecting one of these different respective services (Steps 7, 10 and 11), embodiments of the invention provide for the subject communications to be secured through Central Master Processing Unit 40. In one presently preferred embodiment depicted in FIG. 1, secured communications are provided through Central Master Processing Unit 40 to Interfaces 70, 80 and 90, thereby providing an opportunity for optional on-line electronic secure sessions between a DER/Entity and a Test Laboratory (e.g. Interface 80), MRO (e.g. Interface 90) and/or one or more Consultants (e.g. Interface 90), i.e., comprising provision for electronic mail, streaming audio and/or streaming video conferencing capabilities. Accordingly, in the latter embodiment (now referring to FIG. 6), the respective selection(s) of a Test Laboratory, (i.e., made using training provided at Level-5 Lab Test Module 122), or of an MRO, (i.e., with training at Level-8 MRO Selection Module 128), or of a Drug Abuse Rehabilitation Professional, (i.e., with training at Level-9 Consultant Selection Module 124), are then each independently implemented (i.e., secure selection being made, supra) at each of the different respective implementation modules, i.e., Modules 112/113, 118/119 and 120/121.

For insuring privacy during all aspects of drug testing, i.e. Step-8 and Step-9, supra, training modules 114 and 116 (FIG. 6), provide a DER access to materials authored by any/all applicable Federal and State regulatory agencies, insurers and local legal counsel; and implementation modules 115 and 117 insure proper methods and record keeping procedures for randomly selecting an individual employee for testing and for maintaining the privacy of the selected employee.

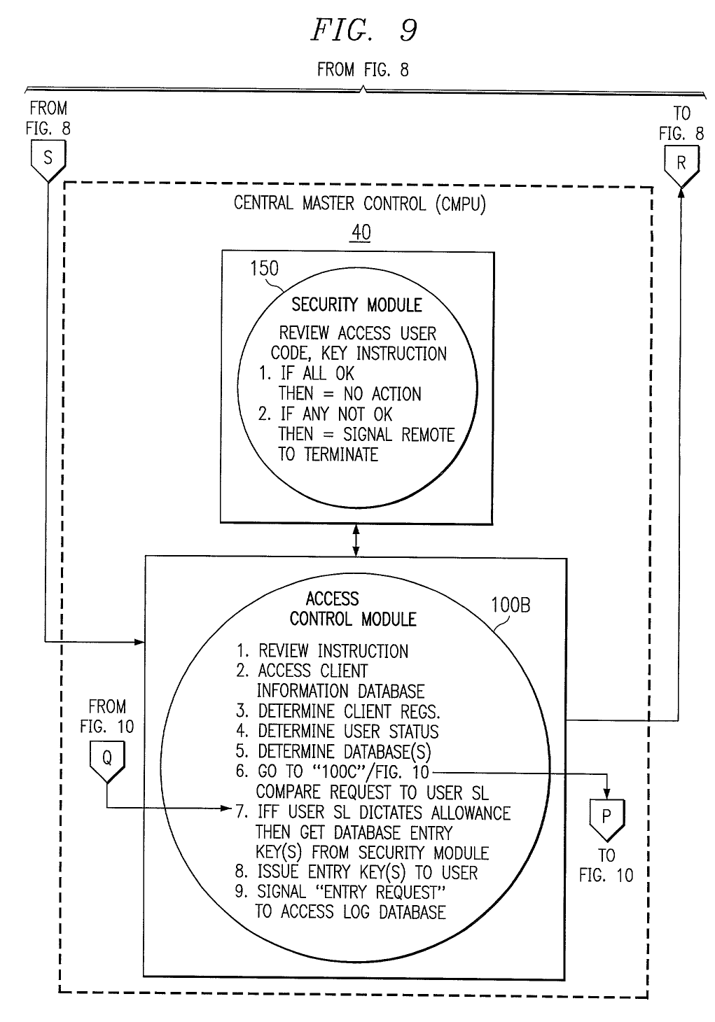

Referring to FIG. 7, illustrative means are depicted for convening an electronic on-line Adverse Action Review Panel, i.e., at “Adverse Action Review Panel Module 125”, in a manner satisfactory to provide Evidence of successful completion of Steps 11-12, supra. In one presently preferred embodiment, depicted in FIG. 1 and FIG. 7 the proceedings are conducted via electronic (e.g., online) teleconferencing, with access of the DER being secured through User Access Module 100 and with secure encryption being administered through Security Module 150 in CMPU 40 Access of the selected MRO, any consultant(s) or legal counsel, to the proceeding is secured through multiple independent Consultant Interfaces 90 (FIGS. 1,7) as directed through and monitored by MRO Access Module 127, Consultant Access Module 128 and Legal Counsel Access Module 129, and as all such activities are encrypted by those respective modules with oversight being administered by a Security Encryption Module 150A operative within, and with administrative oversight provided by, Security Module 150 (disclosed in greater detail below in regard to FIG. 9). The option for possible future regulatory and/or legal review and auditing of actions taken by the subject review panel is provided for in Adverse Action Response Oversight Module 210, which records the confidential proceedings digitally and files them at a secure site in a manner insuring confidentiality and future possible access by duly authorized representatives of the Entity, i.e., provision being made for secure access to those stored materials by such representatives, e.g., through a “Consultant” Interface 90. Status Level Module 170 audits and authenticates that (i) the proceedings have taken place in a private secured confidential manner; (ii) the nature of the proceedings (e.g., a positive test assay report not attributable to a medical condition); (iii) the panel members electronically present; (iv) that a decision has been reached (without identifying an employee by name) that an action has been taken; (v) and forwards the results to Certification Module 200. Certification Module 200 reviews the findings and makes a digital determination that: (a) all appropriate and necessary steps have been taken by the review panel to fulfill applicable regulatory requirements and/or recommended guidelines; (b) makes recommendations to the panel in regard to any hardcopy, or digital, form documents that may need to be considered for completion by the panel; and, (c) makes a determination as to whether there is a need to seek human intervention, e.g., in the event that legal requirements are not be met by the panel. Should human intervention be required to protect privacy and/or security, provision is made for premature termination of the subject adverse action review proceeding and for possible human review and intervention with the DER, MRO, Entity and/or panel members before manually resetting the subject User/DER access at the SL-12 level.

In regards to User access to a Remote Server 30 through User Interface 10 or 20 (FIG. 1) and how that may be achieved in a secure manner according to embodiments of the invention using User Access Module 100 and Security Module 150 (FIGS. 2,5), FIG. 8 depicts an illustrative set of interactive processing instructions at Remote Server 30, i.e., in a command and response format, for controlling User/DER access, i.e., at User Interface 10, and for insuring that the instant processes (set forth supra) are completed in a stepwise fashion. As depicted in FIG. 9, higher level security control is exerted by CMPU 40 over instructions issued by a User/DER at User Interface 10/20 (FIG. 8) and directed to CMPU 40 e.g., through Remote Server 30 (FIGS. 1, 8). Representative processing instructions at User Access Module 100 may comprise e.g. the following: namely,

at “OPERATIONS” (FIG. 8) User Access Module 100 at Server 30 receives digital electronic instructions (“Instruction”, FIG. 8) from the User/DER along with identification information (“ID”, FIG. 8), password and requested access Status Level, User computer identity information, hard-wired or programmed digital signature information (“Key”, FIG. 8) and forwards that digital information in a secure manner to CMPU 40; then,

at “PROCESSING PROCEDURE” (FIG. 8) Module 100A at CMPU 40 processes the User derived information; refers to Module 100B for processing of security information, i.e., an On-Off programming switch referred to a “Entry Key” wherein a User with proper identity (e.g. password, question-and-answer set, proper telephone line, proper computer identity, etc.) is issued a “Entry Key” good for access at a given Status Level for the duration of a session; then, when/if identity is confirmed, the instruction set processing initiates a session at the subject Status Level, e.g., “IF SU THEN”, FIG. 8; at Module 100B (FIG. 9), with oversight from Security Module 150 in CMPU 40, instructions from the user are:

a Reviewed for appropriateness (“Review Instructions”, FIG. 9), e.g., is the instruction one that is recognized by the system or an attempted break-in. If inappropriate the contact is broken at FIG. 8, Module 100;

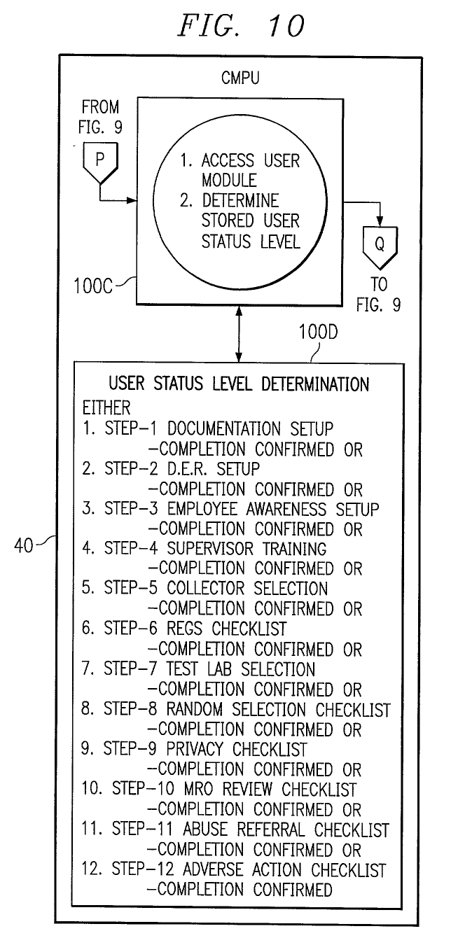

b If appropriate, a client information database is accessed (“Access Client Information Database”, FIG. 9) to determine the applicable Federal, State, local or insurer regulations (“Client Regs.”, FIG. 9), the User Status Level (“User Status”, FIG. 9) and the databases to which access may be granted (“Determine Database(s)”, FIG. 9), i.e., as depicted via the “P” (FIG. 9) directed Query pathway to Access User Module 100C (FIG. 10) and User Status Level Determination Module 100D (FIG. 10). When this processing is successfully completed the information is forwarded from Module 100C to Module 100B, i.e., via “Q” from FIG. 10 back to FIG. 9;

c If the information received from Module 100B is in agreement with the User instructions forwarded from Module 100 (FIG. 8) and with the currently in-force Status Level designation for the entity (as determined by Modules 100C and 100D, FIG. 10), then Module 100B forwards the information to Security Module 150 and requests an “Entry Key”; and,

d Security Module 150 (FIG. 9) reviews the identification information, user instructions, SL designation and the like, and if appropriate, issues encryption keys and/or Entry Key(s) to Access Control Module 100B (FIG. 9) and the Entry Key(s) is passed along to Module 100A (FIG. 8), i.e., via route “R”;

e optionally, at Module 100B, processing instructions are read and executed to access Security Module 150 and to determine whether any irregularities exist in the transmission from Server 30 or from User Interface 10/20, e.g., to identify contact initiated from an unauthorized phone number, in this and other cases, it is understood that provision is provided for Security Module 150 to access directly the information stored in one or more User Databases;

f at Module 100B, after any Security Module 150 oversight in steps-(iii-iv) is complete, processing instructions are read and executed to issue coded “Entry Keys” to User Access Module 100 (FIG. 8). The latter “Entry Keys” are effective to authorize access of the verified User/DER to Training and Implementation Modules, but only at the current User/DER Access SL and only for the course of a single session. Preferably, the instant “Entry Keys” comprise one or more digital keys for enabling 2-way encrypted communications between the User and the particular Training and Implementation Modules to be accessed during the subject system. It is understood that in certain alternative embodiments, the instant Entry Keys may comprise a second key, (i.e., separate and distinct from any first encryption key that may have been used in steps i-ii, above, to secure communications between the User Interface 10/20 and Server 30). It is also understood that the second encryption key may supplant the first key in communications between User Interface 10/20, and/or it or a third, or a fourth or a fifth encryption key may be used in an additive manner to secure communications between the Server 30 and Security Module 150 CMPU 40, i.e., multiple lock processing systems being presently preferred; and,

g Returning from FIG. 9 to FIG. 8 via the route indicated at “R”, at “PROCESSING PROCEDURE” (FIG. 8) Module 100A, processing instructions are read and executed to determine whether the instructions for database access issued from the User/DER are authorized at the current User/DER Access SL, i.e., which Keys have been issued in step-vi, above, and if authorized, the instructions direct access to the appropriate Training and Implementation modules (e.g., IF “SU”, IF “0”, IF “1”, IF “2” and IF “3”, FIG. 8).

According to step (iii), above, it is presently preferred that the User identification data accessed and reviewed by Security Module 150 includes e.g. stored data at a User Data Module 160 (FIG. 2), preferably maintained at CMPU 40. User Data Module 160 preferably includes at least: user identification (“ID”) information for authorized Users/DERs (supra); password(s); confirming personal information; client dial-up telephone number(s); User computer signature; additional Drug Test system administrator hardwired and/or programmed computer digital identification information; and, Authorized Access “Status Level”. In conjunction with retrieval of stored digital User information from one or more databases, to be processed by one or more of the instant Modules, (according to the instant methods), it may prove desirable to verify (by application of a hardware or software information validator, e.g., a data-integrity test) that the subject information so-obtained can be considered reliable (i.e., integral, not corrupt and/or not modified) and/or up-to-date (i.e., current). In the event that the subject digital information fails one or more of the subject tests, it may prove desirable to access and retrieve the subject information from an alternative source (e.g., a redundant database, a partially redundant database, or a series of dispersed redundant sub-component databases). The subject alternative source databases may be located at one or more storage sites within CMPU 40, or alternatively, at CMPU 40 units in physically separate computer systems. It will thus be understood that according to the methods of the invention, User database, and other, information is preferably subject to periodic archiving, and/or digital creation of alternative or partially-redundant versions. A variety of methods are known to those of skill in the art of securing archival digital information, and it will be understood that the methods of the invention will not be viewed as being limiting to any particular individual method. Embodiments of the invention also provide provision for information “validators”, i.e., digital signatures and/or programming modules capable of determining data reliability. Where a first-called-upon database is found not to contain the most reliable available data responsive to a particular query, in presently preferred embodiments the invention provides software, i.e., one or more programming instructions referred to herein as a “redirector”; and/or, hardware, e.g. a “switch”. In either of the latter instances, the software “redirector” or the hardware “switch” is effective to redirect the query to one or more identified alternative databases containing higher quality, or more current data.

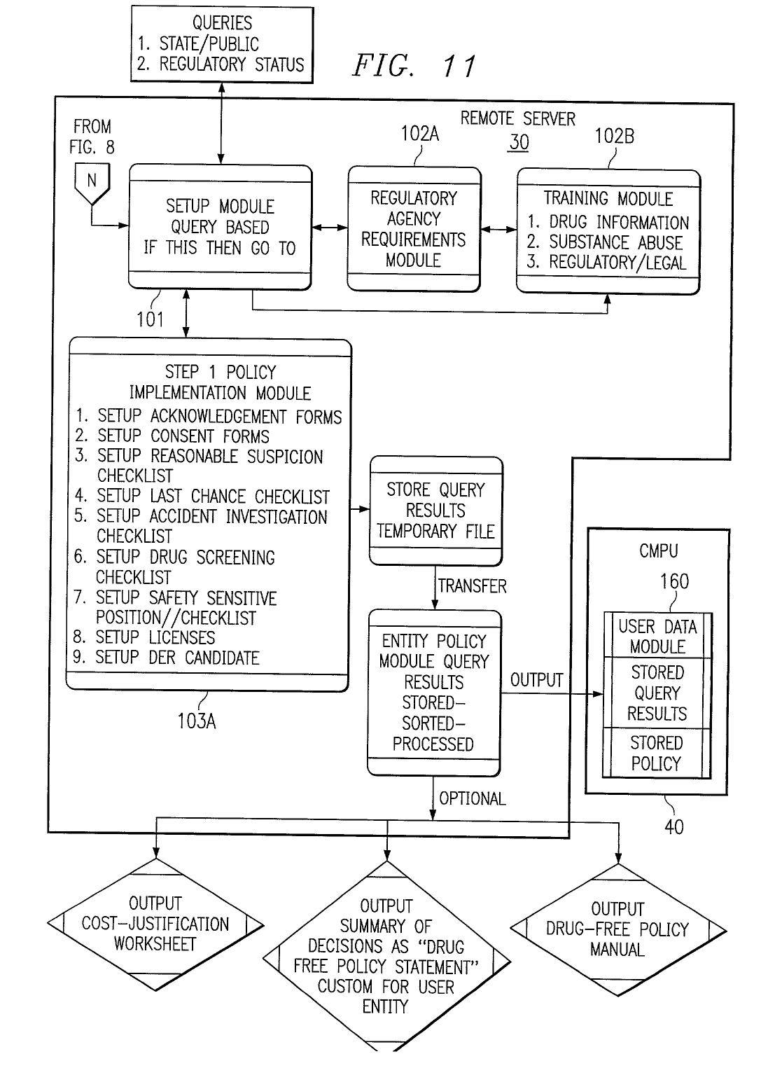

In regard setting up a policy for a new User, i.e., Module 101/102 (FIG. 3), FIG. 11 depicts illustrative processing instructions, i.e., command and response sets, at Remote Server 30 for controlling User/DER Level-SU access to the various processor instructions and functions necessary to complete Step-1, supra. At an illustrative Status Level-0 Setup Training Module 101, a DER-candidate is provided a secure internet/intranet access to State and Local statutes, regulations and/or insurance company recommendations and policies. At Training Modules 102 (FIG. 3), and 102A/102B (FIG. 11), a User/DER-candidate is provided Training as to possible Regulatory Agency Requirements 102A and Substance Abuse in general 102B. At an illustrative Step-1 “Policy Setup” Implementation Module 103A (FIGS. 3,11) a User/DER-candidate is provided, in digital form, a variety of possible required regulatory and/or insurance Form documents such as may be required for compliance. Available for download by the DER, are customized draft documents, and customized Templates such as may be useful and/or required to establish and/or maintain a drug free workplace policy at the Entity. Also at Module 103A, in presently preferred embodiments, the processing instructions provide provisions for a user/DER-candidate to download an Entity-customized “Draft: Drug Free Policy Statement” and a “Draft: Drug Free Policy Manual”, i.e., with customization based on the results of the User/DER-candidate responses to specific queries issued by processing instructions resident in Module 103A. When Setup is digitally determined to be complete, after auditing and authenticating the training materials accessed by the User, (e.g., according to processing instructions stored in an optional Training Monitor 190 FIG. 3), in Training Module 102A/102B, the Status Level Module 170 recommends and Certification Module 200, if appropriate, issues an SL-0, or SL-1, designation to the User/DER-candidate.

Hardware suitable for use in User Interface 10, Collection Site Interface 70, Test Lab Interface 80, Consultant Interface 90, (FIG. 1), i.e., digital electronic apparatus, include those devices providing a User the ability to conduct interactive digital electronic sessions with a Remote server or CMPU, or through the CMPU, with another human user, e.g., a consultant, a test lab or a collection center. Representative examples of hardware so suitable include, e.g., personal computers equipped with keyboards, mouse, voice recognition and the like. Representative hardware suitable for use in Remote Server 30 and Central Master Processing Unit 40 include a variety of networkable server computers. The system and method of the present invention is scalable and not computer-platform dependent. A variety of alternative computer software operating systems (e.g., DOS, Windows, Linux and UNIX-based systems) and/or programming languages may be applied to processing the various instructions needed to implement Steps 1-12, supra, in connection with the present invention.

While certain preferred embodiments of the invention have been illustrated and described herein for exemplary purposes, it will be appreciated by those of ordinary skill in the art that that various changes can be made therein, and the present invention can be embodied in a number of different and additional useful manners, without departing from the spirit and scope of the invention, which are limited only by the claims set forth below.

We claim:

1. A method for implementing a drug free workplace policy at an entity site, said method comprising the steps of:
(i) establishing a drug free workplace policy;
(ii) selecting and training a designated employer representative;
(iii) training employees as to said drug free workplace policy;
(iv) training supervisory personnel of the employer as to legal guidelines for drug testing of employees;
(v) selecting a collection center for collection of a test sample; and,
(vi) selecting a testing laboratory for introduction of said test sample into a drug test assay,
wherein digital electronic apparatus is employed in at least two of steps (i) through (vi) of said method.

2. The method of claim 1, wherein said digital electronic apparatus comprises at least one computer processing unit.

3. The method of claim 2, wherein said method employs at least a first and a second computer processing unit and a communications link between said first and second processing units.

4. The method of claim 3, wherein said communications link comprises a secure link.

5. The method of claim 4, wherein said secure link is selected from the group consisting of a secure dedicated land line, a secure intranet link, a secure wireless link, and a secure encrypted internet link.

6. The method of claim 2, wherein said method employs two automated computer processing units interconnected as part of a data network.

7. The method of claim 6, further comprising auditing through digital electronic apparatus in a manner effective to create a digital record of the instructions issued from a user at said computer processing unit during a working session comprising one or more of said steps.

8. The method of claim 7, further comprising authenticating through digital electronic apparatus that said record reflects processing of instructions sufficient for substantial completion of each step of the method, wherein said authenticating process comprises comparing an actual user activity to a model user activity and finding that both of said activities are substantially the same.

9. The method of claim 8, wherein said actual user activity so compared comprises a user action time and said model user activity so compared comprises a model user action time.

10. The method of claim 8, wherein said actual user activity so compared comprises a user database accession activity sequence and said model user activity so compared comprises a model user database accession activity sequence.

11. The method of claim 8, further comprising certifying through digital electronic apparatus that said at least one step has been substantially completed by a process of determining that said audit process and said authenticating process are substantially complete.

12. The method of claim 7, wherein said step for training supervisory personnel comprises one or more digital training materials for teaching both of (a) risks associated with a possible employee legal challenge to an allegedly-unfair drug test and (b) a proposed legal defense for an employer to assert as a fairness rationale for a drug testing program.

13. The method of claim 3, further comprising the additional steps of:
randomly selecting through digital electronic means an employee for a drug test,
collecting a test specimen at said selected collection center,
transmitting said test specimen to said selected test laboratory, conducting a diagnostic assay and digitizing the resultant data thereof,
communicating said digitized test result on said communications link to one or more of said computer processing units, and
securing the integrity of said communication of said test result data.

14. The method of claim 13 wherein said integrity-securing step comprises communicating said test result data in a manner effective to prevent one or more of: (a) data corruption; (b) tampering; (c) unauthorized access; and (d) non-confidential disclosure.

15. The method of claim 14, wherein said integrity-securing step is implemented at least in part by at least one automated computer security routine.

16. The method of claim 15, wherein said integrity-securing step comprises two or more partially-redundant computer security routines.

17. The method of claim 16, wherein said partially-redundant computer security routines include at least one firewall.

18. The method of claim 16, wherein said computer security routines include at least one high-level data encryption step.

19. The method of claim 14, wherein said method is implemented at least in part over a distributed data network.

20. The method of claim 19, wherein said distributed data network comprises at least one of an internet connection, an intranet, or a website.

21. The method of claim 20, wherein each of ordinal steps (i) through (vi) is substantially completed before the successive ordinal step is begun.

22. The method of claim 15, further comprising at least one of the additional steps of:
(A) selecting a medical review officer;
(B) selecting a substance abuse professional;
(C) conducting an auction to select at least one service from the group of services consisting of: a collection site service, a test laboratory service, a medical review officer service, a medical substance abuse professional service, and a legal substance abuse professional service;
(D) conducting a consultation between the designated employer representative and a medical review officer;
(E) conducting a consultation between the designated employer representative and the substance abuse professional; and
(F) conducting an adverse action review.

23. The method of claim 22, wherein said at least one additional step comprises an automated computer processing step and wherein the drug test assay is performed to yield drug test results.

24. The method of claim 23, wherein at least additional steps (A)-(C) are performed by digital electronic apparatus.

25. The method of claim 23, wherein at least additional steps (D)-(F) are performed by digital electronic apparatus.

26. The method of claim 23, wherein each of additional steps (A)-(F) is performed by digital electronic apparatus.

27. The method of claim 23, wherein each of said additional steps (A)-(F) is substantially completed by digital electronic apparatus in ordinal fashion beginning with step (A) and proceeding through step (F) before commencement of a following ordinal step.

28. An adaptable computer-implemented system for implementing an employer's drug use policy, comprising:
at least one computer memory;
a system administrator interface through which a system administrator may substantially instantaneously request updating of information in a first database relative to at least one of (a) current employer drug use policies; (b) drug use policy training materials for employees and supervisors; (c) legal standards for acceptable employer drug use policies; (d) insurance standards for employer drug use policies; (e) preferred providers for services relating to drug use policies; and (f) secured input and output data for individual employee drug test assay results
a user interface with which a user can issue a request for access to information in a second database related to the employer drug policy and stored in a computer memory linked to said user interface;
a central master control processor for processing said user request for access;
an information validator operational at said central master control processor to refuse user access to said second database if said second database contains substantially unreliable information; and
a redirector operational at said central master control processor for redirecting the user access request to a database deemed to contain more reliable information when said second database is deemed to contain substantially unreliable information..

29. The system of claim 28, wherein said first and second databases share at least some common information.

30. The system of claim 29, further comprising a security module.

31. The system of claim 30, wherein said security module comprises at least one of a firewall and a high-level encrypter/decrypter.

32. The system of claim 31, further comprising at least one output device for access to information from at least one of said databases.

33. The system of claim 32, further comprising at least one electronic data communications link for remote processing of requests relating to at least one of said databases.

34. The system of claim 33, wherein said data communication link comprises a user connection over at least one of (i) the internet; (ii) an intranet; or (iii) a website.

35. A method for implementing an entity drug free workplace policy comprising the steps of:
(a) formulating the drug free workplace policy;
(b) identifying and storing in a first database processing instructions and digital data relating to a method for at least one of:
(i) training a designated employee representative;
(ii) training an employee as to the drug free workplace policy;
(iii) training a supervisor as to an employee activity not in compliance with the drug free workplace policy;
(iv) selecting one or more collection center service providers to collect an employee sample for a drug;
(v) selecting one or more laboratory test service providers to analyze said employee sample for said drug;
(vi) selecting one or more service providers to review an employee drug test result;
(c) selecting randomly at least one employee from among a plurality of employees for a drug use test;
(d) collecting a test specimen from said random-selected employee, digitally encoding the identity of the employee, and submitting said digitally identified test specimen for drug testing;
(e) determining a value for a drug analyte in said digitally identified test specimen;
(f) storing said identity of said employee and said digital drug analyte value in a secured second database; and,
(g) providing secured access to said second database only to designated delegates of said entity,
wherein at least one of said steps (a)-(g) is performed through digital electronic apparatus.

36. The method of claim 35, further comprising monitoring said drug free workplace policy by auditing, authenticating and certifying completion of steps (a) through (g).

37. The method of claim 35, further comprising confirming said drug free workplace status of said entity by auditing, authenticating and certifying completion of steps (a) through (g).

38. The method of claim 35, further comprising the step of:
(h) providing said designated employee representative with a remote access to said processing instructions and said data stored in said first database.

39. The method of claim 35, further comprising the step of:
(i) providing said reviewing service provider with a remote access to said digital employee identity and said digital drug analyte value stored in said second database.

40. The method of claim 36, further comprising the step of:
(j) providing said designated employee representative with a remote access to said reviewing service provider.

41. A method for monitoring drug usage among a human entity population, said method comprising the steps of
(i) establishing a drug control policy for the entity population;
(ii) identifying and training a designated representative to implement said policy;
(iii) informing members of the entity population as to said drug free workplace policy;
(iv) selecting a collector center and collecting a test specimen from a member of said Entity population; and,
(v) selecting a testing laboratory and introducing said test specimen into a drug test assay at said testing laboratory;
wherein said method is conducted at least in part by digital electronic apparatus employing computer processing to effect each of said steps (i) through (v), and wherein each of said steps (i) through (v) is performed substantially in ordinal series.

42. The method of claim 41, further comprising the step of training supervisory personnel of the entity as to legal guidelines for drug testing of employees, wherein said step is implemented at least in part by computer processing, and wherein said step is performed substantially after step (ii) and before step (iii).

43. The method of claim 41, wherein completion of each of said steps is audited, authenticated and certified by digital electronic apparatus.

44. The method of claim 43, further comprising the steps of data handling and transmission of a drug test assay result to a reviewer in a secure manner, wherein said data handling and transmission steps both include a high level of security.

45. The method of claim 44, wherein said data transmission step comprises at least in part transmission over a distributed computer network.

46. The method of claim 45, wherein said entity population comprises employees of an organization, and said designated representative comprises a designated employer representative.

47. A method for implementing a drug free workplace program comprising the steps of:
(i) providing at least one digital electronic training module for providing instruction an employer drug use policy; and
(ii) providing at least one digital electronic implementation module for processing instructions and data relative to employee compliance with said drug use policy,
wherein said training and implementation modules both comprise software programs suitable for processing by a computer operating system.

48. The method of claim 47, wherein said training and implementation modules each individually comprise more than two constituent software modules.

49. The method of claim 48, further comprising the steps of recording and storing in a session log a user action relating to execution of a processing instruction in both of said modules.

50. The method of claim 49, further comprising the step of auditing the stored recorded data in said session logs to verify a substantial compliance with a drug free workplace program, wherein said compliance comprises meeting both a minimum defined requirement for training and a minimum defined requirement for implementation of a drug free workplace policy.

51. A method for controlling employer costs associated with possible employee drug usage, comprising the steps of:
(i) identifying at least one employee drug use policy-related cost selected from (a) productivity loss; (b) insurance risk; (c) regulatory risk; (d) litigation costs; and
(ii) formulating an employer drug free workplace program seeking reduction of at least said cost,
wherein said program is implemented in stepwise, electronic-media-assisted, high-security fashion, and wherein historical data documenting said program implementation is maintained.

52. The method of claim 51, wherein said electronic media comprise computer processing.

53. The method of claim 52, wherein said computer processing comprises communication over at least one distributed data network.

54. The method of claim 53, wherein said computer processing comprises the step of controlling user access to stored program-related data.

55. The method of claim 54, wherein said access control comprises selecting specific centrally-stored data relating to one of (i) program training and (ii) program implementation for display to a remote user based on the user's access privileges.

56. The method of claim 55, wherein said network comprises at least one of:
(1) an intranet;
(2) a website connection; and
(3) the internet.

57. A method for implementing a drug free workplace policy at an entity site, said method comprising the steps of both:
(i) establishing through digital electronic apparatus a drug free workplace policy; and,
(ii) training through digital electronic apparatus a designated employer representative.

58. The method of claim 57, further comprising the step of training through digital electronic apparatus employees of the entity as to said drug free workplace policy.

59. The method of claim 57, further comprising the step of training through digital electronic apparatus supervisory personnel of the entity as to legal guidelines for drug testing of employees.

60. The method of claim 57, further comprising the step of selecting through digital electronic apparatus a collection center for collection of a test sample from at least one employee of the entity.

61. The method of claim 57, further comprising the step of selecting through digital electronic apparatus a testing laboratory for introduction of said test sample into a drug test assay.

62. The method of claim 61, further comprising the step of introducing said test sample into the drug test assay at said testing laboratory, conducting the drug test assay to obtain test results, and taking further action responsive to a report of said test result for the employee if said test result indicates the presence in said test sample of a substance prohibited by said policy.
